(19) United States
(12) Patent Application Publication
(10) Pub. No.: US 2025/0391418 A1
(43) Pub. Date: Dec. 25, 2025

(54) AUDIO ENCODING METHOD, AUDIO DECODING METHOD, AND RELATED APPARATUS

(71) Applicant: HUAWEI TECHNOLOGIES CO., LTD., Shenzhen (CN)

(72) Inventors: Chunhui Du, Shenzhen (CN); Fan Fan, Shenzhen (CN); Zhuo Wang, Shenzhen (CN); Bin Feng, Shenzhen (CN)

(73) Assignee: HUAWEI TECHNOLOGIES CO., LTD., Shenzhen (CN)

(21) Appl. No.: 19/312,450

(22) Filed: Aug. 28, 2025

Related U.S. Application Data
(63) Continuation of application No. PCT/CN2023/133321, filed on Nov. 22, 2023.

(30) Foreign Application Priority Data
Feb. 28, 2023 (CN) 202310233443.4

(51) Int. Cl. G10L 19/008; G10L 19/002; G10L 19/035

(52) U.S. Cl. CPC G10L 19/008; G10L 19/002; G10L 19/035

(57) ABSTRACT

An example audio encoding method includes determining a current bandwidth cut-off coefficient based on a quantity of currently used bits, a quantity of channels, and a quantity of sampling points that are of an audio signal, determining m current to-be-encoded sub-bands based on the current bandwidth cut-off coefficient, encoding target quantization scales respectively corresponding to the m sub-bands into a bitstream based on the current bandwidth cut-off coefficient, allocating quantization bits to the m sub-bands based on current remaining quantization scales respectively corresponding to the m sub-bands, and encoding frequency band information in the m sub-bands into the bitstream based on the quantization bits allocated to the m sub-bands. The target quantization scale is a quantity of bits required for encoding frequency band information with a maximum amplitude in a corresponding sub-band.

### CROSS-REFERENCE TO RELATED APPLICATIONS

This application is a continuation of International Application No. PCT/CN2023/133321, filed on Nov. 22, 2023, which claims priority to Chinese Patent Application No. 202310233443.4, filed on Feb. 28, 2023. The disclosures of the aforementioned applications are hereby incorporated by reference in their entireties.

### TECHNICAL FIELD

This application relates to the audio encoding and decoding field, and in particular, to an audio encoding method, an audio decoding method, and a related apparatus.

### BACKGROUND

As quality of life is improved, people's requirements for high-quality audio are increasing. To better transmit an audio signal on a limited bandwidth, the audio signal usually needs to be encoded first on an encoder side, to obtain a bitstream. Then, the bitstream is transmitted to a decoder side. The decoder side decodes the received bitstream, to reconstruct the audio signal. The reconstructed audio signal is used for playback.

However, a current encoding manner supports either lossy encoding or lossless encoding, and cannot support both a lossy feature and a lossless feature, resulting in low efficiency of switching between lossy encoding and lossless encoding. In addition, when an encoding bit rate on the encoder side changes, encoding needs to be performed again, and a channel adaptive capability during audio signal transmission is greatly increased.

### SUMMARY

This application provides an audio encoding method, an audio decoding method, and a related apparatus, to support both a lossy feature and a lossless feature, and further improve a channel adaptive capability of an audio signal in a communication process. The technical solutions are as follows.

According to a first aspect, an audio encoding method is provided. The method includes: determining a current bandwidth cut-off coefficient based on a quantity of currently used bits, a quantity of channels, and a quantity of sampling points that are of an audio signal, where the quantity of currently used bits is a quantity of bits consumed by encoding a spectrum of a current audio frame of the audio signal before current time; determining, based on the current bandwidth cut-off coefficient, m current to-be-encoded sub-bands from a plurality of sub-bands included in the spectrum, where m is greater than or equal to 1 and less than or equal to a total quantity of the plurality of sub-bands; encoding target quantization scales respectively corresponding to the m sub-bands into a bitstream based on the current bandwidth cut-off coefficient, where the target quantization scale is a quantity of bits required for encoding frequency band information with a largest amplitude in a corresponding sub-band; allocating quantization bits to the m sub-bands based on current remaining quantization scales respectively corresponding to the m sub-bands, where the current remaining quantization scale is an unallocated quantization scale remaining after a quantization bit is allocated to a corresponding sub-band last time; and encoding frequency band information in the m sub-bands into the bitstream based on the quantization bits currently allocated to the m sub-bands.

In this application, hierarchical quantization and encoding are performed on the sub-band included in the spectrum. An insufficient bit rate corresponds to a state of lossy encoding, and an enough bit rate corresponds to a state of lossless encoding. In other words, the quantization and encoding manner provided in this application can support both a lossy encoding feature and a lossless encoding feature, to greatly reduce algorithm complexity and avoid low-efficiency switching between a lossy framework and a lossless framework. In addition, in a process of hierarchical quantization and encoding, quantization is performed while encoding is performed, to randomly truncate an encoded bitstream when a bit rate changes. In other words, an audio frame encoded in this solution has a single-frame multi-bit rate feature. Compared with a manner in which quantization is performed before encoding, this solution can avoid a case in which truncation cannot be performed and encoding needs to be performed again when the bit rate changes, to greatly improve channel adaptive capability in a communication process.

In this application, hierarchical quantization and encoding may be performed on the sub-band included in the spectrum of the current audio frame of the audio signal, or a plurality of times of cyclic quantization and encoding may be performed. A high bandwidth is not necessarily encoded at a low bit rate, and a higher bandwidth may be encoded only at a specific bit rate. In other words, frequency band information in all sub-bands is not necessarily encoded at the low bit rate, and only frequency band information in some sub-bands may need to be encoded. Therefore, in each cycle of hierarchical quantization, a maximum bandwidth allowed to be encoded in a case of the quantity of currently used bits, namely, a current to-be-encoded maximum sub-band, may be determined. The current to-be-encoded maximum sub-band may be determined based on the current bandwidth cut-off coefficient.

Because the plurality of times of cyclic quantization and encoding are performed on the sub-band included in the spectrum of the current audio frame of the audio signal, the quantization bits allocated to the m sub-bands based on the current remaining quantization scales respectively corresponding to the m sub-bands may also be referred to as the quantization bits currently allocated to the m sub-bands, or quantization bits allocated to the m sub-bands in a current cycle.

It should be noted that a quantization and encoding process is performed for audio frames one by one. An encoder side can perform quantization and encoding on each audio frame according to this solution. The spectrum of the current audio frame of the audio signal is a spectrum obtained after windowing and folding transform are performed on the current audio frame. The quantity of sampling points of the audio signal is a quantity of sampling points included in the audio frame.

The current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists.

In a possible implementation, the current bandwidth cut-off coefficient may be multiplied by the quantity of sampling points of the audio signal, to obtain a current cut-off frequency. A sub-band in which the current cut-off frequency is located is determined from the plurality of sub-bands included in the spectrum of the current audio frame of the audio signal, and then a sub-band before the sub-band in which the current cut-off frequency is located in the plurality of sub-bands is determined as the m current to-be-encoded sub-bands.

It should be noted that, in each quantization cycle, the current bandwidth cut-off coefficient dynamically changes. In this way, values of m determined based on the current bandwidth cut-off coefficient may be different. In addition, the m current to-be-encoded sub-bands may include the sub-band in which the current cut-off frequency is located, or may not include the sub-band in which the current cut-off frequency is located.

Based on the foregoing descriptions, the current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists. In a case of the full band and the non-full band, the target quantization scales respectively corresponding to the m sub-bands are encoded into the bitstream in different manners, which are separately described below.

In a first case, when the current bandwidth cut-off coefficient indicates the non-full band, a difference between target quantization scales of every two adjacent sub-bands in the m sub-bands is determined, to obtain m-1 quantization scale differences; a smallest value and a largest value in the m-1 quantization scale differences are determined; and the target quantization scales respectively corresponding to the m sub-bands are encoded into the bitstream in a differential encoding manner if the smallest value is greater than a first threshold and the largest value is less than a second threshold.

When the current bandwidth cut-off coefficient indicates the non-full band, it indicates that the target quantization scales respectively corresponding to the m sub-bands further include a target quantization scale that is not encoded into the bitstream. That is, encoding of the target quantization scales respectively corresponding to the m sub-bands is not completed. In this case, the target quantization scales respectively corresponding to the m sub-bands may be encoded into the bitstream in the foregoing manner.

In a second case, when the current bandwidth cut-off coefficient indicates the full band, the target quantization scales respectively corresponding to the m sub-bands do not need to be encoded into the bitstream.

When the current bandwidth cut-off coefficient indicates the full band, it indicates that all the target quantization scales respectively corresponding to the m sub-bands are encoded into the bitstream. In this case, the target quantization scales respectively corresponding to the m sub-bands do not need to be encoded into the bitstream.

It should be noted that one sub-band includes a plurality of frequency bands, each frequency band has one piece of corresponding frequency band information, and the frequency band information represents the corresponding frequency band. The frequency band information may include an amplitude and a positive/negative sign of the amplitude. In other words, a value of the frequency band information may include a positive number, or may include a negative number. When the frequency band information is encoded into the bitstream, the amplitude and the positive/negative sign included in the frequency band information may be encoded into the bitstream. In addition, usually, the amplitude and the positive/negative sign included in each piece of frequency band information are encoded separately.

When the current remaining quantization scales respectively corresponding to the m sub-bands are different, the quantization bits are allocated to the m sub-bands in different manners, which are separately described below.

In a first case, when the current remaining quantization scales respectively corresponding to the m sub-bands are all 0s, a quantization and encoding cycle of the spectrum of the audio signal ends.

When the current remaining quantization scales respectively corresponding to the m sub-bands are all 0s, it indicates that the plurality of sub-bands included in the spectrum of the audio signal are all encoded into the bitstream. In this case, a quantization and encoding cycle of the plurality of sub-bands may be ended, and a quantization and encoding cycle of a sub-band included in a next spectrum is performed.

In a second case, the quantization bits are allocated to the m sub-bands based on the current remaining quantization scales respectively corresponding to the m sub-bands when the current remaining quantization scales respectively corresponding to the m sub-bands are not all 0s and are all less than a quantization step.

When the current remaining quantization scales respectively corresponding to the m sub-bands are not all 0s, it indicates that the m sub-bands further include a sub-band whose encoding is not completed in the m sub-bands. Therefore, the quantization bits further need to be allocated to the m sub-bands. When the current remaining quantization scales respectively corresponding to the m sub-bands are all less than the quantization step, it indicates that the quantization bits of the m sub-bands are all within a range of the quantization step. Therefore, the current remaining quantization scales respectively corresponding to the m sub-bands may be directly used as the quantization bits allocated to the m sub-bands.

In a third case, when a current remaining quantization scale of at least one of the m sub-bands is greater than a quantization step, psychoacoustic masking is performed on the current remaining quantization scales respectively corresponding to the m sub-bands, to obtain masked remaining quantization scales respectively corresponding to the m sub-bands; the masked remaining quantization scales respectively corresponding to the m sub-bands are scaled based on the quantization step, to obtain scaled remaining quantization scales respectively corresponding to the m sub-bands; and the quantization bits are allocated to the m sub-bands based on the scaled remaining quantization scales respectively corresponding to the m sub-bands and the target quantization scales respectively corresponding to the m sub-bands.

When the current remaining quantization scale of the at least one of the m sub-bands is greater than the quantization step, it indicates that quantization bits of some of the m sub-bands are not within a range of the quantization step. Therefore, the remaining quantization scales respectively corresponding to the m sub-bands need to be processed in a psychoacoustic masking manner, to distinguish importance degrees of the m sub-bands.

Because hierarchical quantization and encoding are performed on the plurality of sub-bands included in the spectrum of the audio signal, for a same sub-band, hierarchical quantization and encoding may also be performed on frequency band information in the sub-band. In other words, different frequency band information in a same sub-band may be located at different quantization layers. When channels of the sub-band are located at different quantization layers, the frequency band information in the sub-band is encoded into the bitstream in different manners. The following provides descriptions by using any one of the m sub-bands as an example.

In a first case, when a current quantization layer quantity of a target sub-band is less than or equal to a maximum quantization layer quantity, if a quantization bit currently allocated to the target sub-band is 1, frequency band information in the target sub-band is encoded into the bitstream in an entropy encoding manner based on the quantization bit currently allocated to the target sub-band. The target sub-band is any one of the m sub-bands.

The current quantization layer quantity of the target sub-band is a ranking of a quantization and encoding cycle in which the frequency band information in the target sub-band is currently encoded. The maximum quantization layer quantity is preset. In different cases, values of the maximum quantization layer quantity may be different.

In a second case, when a current quantization layer quantity of a target sub-band is less than or equal to a maximum quantization layer quantity, if a quantization bit currently allocated to the target sub-band is greater than 1, frequency band information in the target sub-band is encoded into the bitstream in a binary encoding manner based on the quantization bit currently allocated to the target sub-band. The target sub-band is any one of the m sub-bands.

In a third case, when a current quantization layer quantity of a target sub-band is greater than a maximum quantization layer quantity, frequency band information in the target sub-band is encoded into the bitstream in a binary encoding manner based on a quantization bit currently allocated to the target sub-band. The target sub-band is any one of the m sub-bands.

In a possible implementation, a current encoding bit rate may be further determined in a process of encoding the frequency band information in the m sub-bands into the bitstream. If the current encoding bit rate is equal to a target encoding bit rate, a hierarchical quantization and encoding cycle of the sub-band included in the spectrum of the current audio frame of the audio signal may be ended.

In other words, a quantization and encoding cycle of a sub-band of a spectrum may be terminated due to an insufficient bit rate. Therefore, an intermediate state of the quantization and encoding cycle corresponds to a lossy encoding state, and automatic encoding is performed to switch to a lossless state at an enough bit rate. Therefore, the framework may support a great bit rate change range of a codec from a lossy state to the lossless state.

The foregoing quantization and encoding process has two distinct features. One feature is a quantization and encoding mode in which quantization is performed while encoding is performed. Different from a manner in which most audio codecs separate a quantization process from an encoding process, the feature enables a decoder side to parse out information as much as received information. Therefore, a decoder has a single-frame multi-bit rate feature. To be specific, after an audio frame is encoded, an encoding bit rate of the audio frame may be truncated randomly, so that the audio frame has different bit rates. Another feature is that a quantization and encoding procedure on an encoder side and a quantization and encoding procedure on the decoder side is highly symmetric. That is, the decoder side and the encoder side each have a quantization procedure, which is different from a manner in which quantization of most encoding and decoding is performed on the encoder side, and the decoder side only needs to parse out quantized information. In this solution, quantization bit allocation at each layer on the encoder side is calculated based on a quantity of encoded bits, and correspondingly, quantization bit allocation at each layer on the decoder side is also calculated based on a quantity of decoded bits. In addition, a same quantization bit allocation mechanism is used. Therefore, both the encoder side and the decoder side learn of how to allocate bits in each quantization cycle.

The audio signal may be an audio signal of a single channel, or may be audio signals of dual channels, or may be audio signals of a plurality of channels. In this embodiment of this application, audio signals of all channels may be separately quantized and encoded, or audio signals of all channels may be mixed together for quantization and encoding.

In an example, the audio signal has side information, the side information includes an encoding flag bit, and the audio signal is an audio signal of a single channel when the encoding flag bit is a first value. That is, the audio signals of all the channels are separately quantized and encoded. The audio signal is audio signals of a plurality of channels when the encoding flag bit is a second value. That is, the audio signals of all the channels are mixed together for quantization and encoding.

Such a manner in which the audio signals of all the channels are separately quantized and encoded facilitates separate transmission or decoding of bitstreams of all the channels. In this case, bit rates of all the channels are evenly allocated. Such a manner in which the audio signals of all the channels are mixed for quantization and encoding, hierarchical quantization and encoding are performed channel by channel. In this case, bit rates of all the channels are dynamically allocated, to achieve relatively optimal bit rate allocation. That is, a result of separate quantization and encoding is that bitstreams of all the channels separately support the single-frame multi-bit rate, and a result of mixed quantization and encoding is that a mixed bitstream of all the channels supports the single-frame multi-bit rate.

According to a second aspect, an audio decoding method is provided. The method includes: determining a current bandwidth cut-off coefficient based on a quantity of currently used bits, a quantity of channels, and a quantity of sampling points that are of an audio signal, where the quantity of currently used bits is a quantity of bits consumed by decoding a spectrum of a current audio frame of the audio signal before current time; determining, based on the current bandwidth cut-off coefficient, m current to-be-decoded sub-bands from a plurality of sub-bands included in the spectrum, where m is greater than or equal to 1 and less than or equal to a total quantity of the plurality of sub-bands; parsing out target quantization scales respectively corresponding to the m sub-bands from a bitstream based on the current bandwidth cut-off coefficient, where the target quantization scale is a quantity of bits required for encoding frequency band information with a largest amplitude in a corresponding sub-band; allocating quantization bits to the m sub-bands based on current remaining quantization scales respectively corresponding to the m sub-bands, where the current remaining quantization scale is an unallocated quantization scale remaining after a quantization bit is allocated to a corresponding sub-band last time; and parsing out frequency band information in the m sub-bands from the bitstream based on the quantization bits currently allocated to the m sub-bands.

In this application, hierarchical quantization and encoding are performed on the sub-band included in the spectrum, to support both a lossy encoding feature and a lossless encoding feature. Therefore, a decoder side can also support both a lossy decoding feature and a lossless decoding feature, to greatly reduce algorithm complexity, and avoid low-efficiency switching between a lossy framework and a lossless framework. In addition, in a process of hierarchical quantization decoding, quantization is performed while decoding is performed. Regardless of how much information is sent by the encoder side, the decoder side may parse out the information from the bitstream, to greatly improve a channel adaptive capability of the bitstream in a communication process. In addition, when the decoder side determines, through parsing, that specific frequency band information is not lossless, a value of the frequency band information may be further padded in a low-order bit padding manner, to reduce an overall quantization error, and effectively compensate for a case in which an amplitude of the audio signal is reduced due to a bit loss in lossy encoding.

Because the plurality of times of cyclic quantization and decoding are performed on the sub-band included in the spectrum of the current audio frame of the audio signal, the quantization bits allocated to the m sub-bands based on the current remaining quantization scales respectively corresponding to the m sub-bands may also be referred to as the quantization bits currently allocated to the m sub-bands, or quantization bits allocated to the m sub-bands in a current cycle.

The current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists. In a case of the full band and the non-full band, the target quantization scales respectively corresponding to the m sub-bands are encoded into the bitstream in different manners, which are separately described below.

In a first case, when the current bandwidth cut-off coefficient indicates the non-full band, the target quantization scales respectively corresponding to the m sub-bands are parsed out from the bitstream.

When the current bandwidth cut-off coefficient indicates the non-full band, it indicates that the target quantization scales respectively corresponding to the m sub-bands further include a target quantization scale that is not parsed out. That is, parsing of the target quantization scales respectively corresponding to the m sub-bands is not completed. In this case, the target quantization scales respectively corresponding to the m sub-bands may be parsed out from the bitstream.

In a second case, when the current bandwidth cut-off coefficient indicates the full band, the target quantization scales respectively corresponding to the m sub-bands do not need to be parsed out from the bitstream.

When the current bandwidth cut-off coefficient indicates the full band, it indicates that all the target quantization scales respectively corresponding to the m sub-bands are parsed out from the bitstream. In this case, the target quantization scales respectively corresponding to the m sub-bands do not need to be parsed out from the bitstream.

When the current remaining quantization scales respectively corresponding to the m sub-bands are different, the quantization bits are allocated to the m sub-bands in different manners, which are separately described below.

In a first case, when the current remaining quantization scales respectively corresponding to the m sub-bands are all 0s, a quantization and decoding cycle of the spectrum of the audio signal ends.

When the current remaining quantization scales respectively corresponding to the m sub-bands are all 0s, it indicates that the plurality of sub-bands included in the spectrum of the audio signal are all parsed out from the bitstream. In this case, a quantization and decoding cycle of the plurality of sub-bands may be ended, and a quantization and decoding cycle of a sub-band included in a next spectrum is performed.

In a second case, the quantization bits are allocated to the m sub-bands based on the current remaining quantization scales respectively corresponding to the m sub-bands when the current remaining quantization scales respectively corresponding to the m sub-bands are all less than a quantization step.

When the current remaining quantization scales respectively corresponding to the m sub-bands are not all 0s, it indicates that the m sub-bands further include a sub-band whose decoding is not completed in the m sub-bands. Therefore, the quantization bits further need to be allocated to the m sub-bands. When the current remaining quantization scales respectively corresponding to the m sub-bands are all less than the quantization step, it indicates that the quantization bits respectively corresponding to the m sub-bands are all within a range of the quantization step. Therefore, the current remaining quantization scales respectively corresponding to the m sub-bands may be directly used as the quantization bits allocated to the m sub-bands.

In a third case, when a current remaining quantization scale of at least one of the m sub-bands is greater than a quantization step, psychoacoustic masking is performed on the current remaining quantization scales respectively corresponding to the m sub-bands, to obtain masked remaining quantization scales respectively corresponding to the m sub-bands; the masked remaining quantization scales respectively corresponding to the m sub-bands are scaled based on the quantization step, to obtain scaled remaining quantization scales respectively corresponding to the m sub-bands; and the quantization bits are allocated to the m sub-bands based on the scaled remaining quantization scales respectively corresponding to the m sub-bands and the target quantization scales respectively corresponding to the m sub-bands.

Because hierarchical quantization and decoding are performed on the plurality of sub-bands included in the spectrum of the current audio frame of the audio signal, for a same sub-band, hierarchical quantization and decoding may also be performed on frequency band information in the sub-band. In other words, different frequency band information in a same sub-band may be located at different quantization layers. When channels of the sub-band are located at different quantization layers, the frequency band information in the sub-band is parsed out from the bitstream in different manners. The following provides descriptions by using any one of the m sub-bands as an example.

In a first case, when a current quantization layer quantity of a target sub-band is less than or equal to a maximum quantization layer quantity, if a quantization bit currently allocated to the target sub-band is 1, frequency band information in the target sub-band is parsed out from the bitstream in an entropy decoding manner based on the quantization bit currently allocated to the target sub-band. The target sub-band is any one of the m sub-bands.

The current quantization layer quantity of the target sub-band is a ranking of a quantization and decoding cycle in which the frequency band information in the target sub-band is currently decoded. The maximum quantization layer quantity is preset. In different cases, values of the maximum quantization layer quantity may be different.

In a second case, when a current quantization layer quantity of a target sub-band is less than or equal to a maximum quantization layer quantity, if a quantization bit currently allocated to the target sub-band is greater than 1, frequency band information in the target sub-band is parsed out from the bitstream in a binary decoding manner based on the quantization bit currently allocated to the target sub-band. The target sub-band is any one of the m sub-bands.

In a third case, when a current quantization layer quantity of a target sub-band is greater than a maximum quantization layer quantity, frequency band information in the target sub-band is parsed out from the bitstream in a binary decoding manner based on a quantization bit currently allocated to the target sub-band. The target sub-band is any one of the m sub-bands.

In a possible implementation, after the parsing out frequency band information in the m sub-bands from the bitstream based on the quantization bits currently allocated to the m sub-bands, the method further includes:
when parsing of the target sub-band ends, if a quantity of parsed-out bits of target frequency band information in the target sub-band is less than a target quantization scale of the target sub-band, performing low-order bit padding on the target frequency band information, where the target sub-band is any one of the m sub-bands, and the target frequency band information is any piece of frequency band information in the target sub-band.

If the quantity of parsed-out bits of the target frequency band information in the target sub-band is less than the target quantization scale of the target sub-band, it indicates that quantization and encoding of the target frequency band information is not lossless. In this case, low-order bit padding may be performed on the target frequency band information, to reduce an overall quantization error, and effectively compensate for a case in which an amplitude of the audio signal is reduced due to a bit loss in lossy encoding. In a process of low-order bit padding, 0 and 1 may be randomly padded, and a padding probability of 0 is the same as that of 1.

According to a third aspect, an audio encoding apparatus is provided. The audio encoding apparatus has a function of implementing a behavior of the audio encoding method in the first aspect. The audio encoding apparatus includes at least one module. The at least one module is configured to implement the audio encoding method provided in the first aspect.

According to a fourth aspect, an audio decoding apparatus is provided. The audio decoding apparatus has a function of implementing a behavior of the audio decoding method in the first aspect. The audio decoding apparatus includes at least one module. The at least one module is configured to implement the audio decoding method provided in the second aspect.

According to a fifth aspect, an audio encoding device is provided. The audio encoding device includes a processor and a memory, and the memory is configured to store a computer program for executing the audio encoding method provided in the first aspect. The processor is configured to execute the computer program stored in the memory, to implement the audio encoding method in the first aspect.

Optionally, the audio encoding device may further include a communication bus. The communication bus is configured to establish a connection between the processor and the memory.

According to a sixth aspect, an audio decoding device is provided. The audio decoding device includes a processor and a memory, and the memory is configured to store a computer program for performing the audio decoding method provided in the first aspect. The processor is configured to execute the computer program stored in the memory, to implement the audio decoding method in the first aspect.

Optionally, the audio decoding device may further include a communication bus. The communication bus is configured to establish a connection between the processor and the memory.

According to a seventh aspect, a computer-readable storage medium is provided. The storage medium stores instructions, and when the instructions run on a computer, the computer is enabled to perform the audio encoding method in the first aspect or the audio decoding method in the second aspect.

According to an eighth aspect, a computer program product including instructions is provided. When the instruction runs on a computer, the computer is enabled to perform the audio encoding method in the first aspect or the audio decoding method in the second aspect. In other words, a computer program is provided. When the computer program runs on a computer, the computer is enabled to perform the audio encoding method in the first aspect or the audio decoding method in the second aspect.

Technical effects achieved in the third aspect to the eighth aspect are similar to the technical effects achieved by using corresponding technical means in the first aspect or the second aspect. Details are not described herein again.

### BRIEF DESCRIPTION OF DRAWINGS

FIG. 1 is a diagram of a Bluetooth interconnection scenario according to an embodiment of this application;

FIG. 2 is a diagram of a system architecture related to an audio signal processing method according to an embodiment of this application;

FIG. 3 is a diagram of an overall framework of audio encoding/decoding according to an embodiment of this application;

FIG. 4 is a flowchart of an audio encoding method according to an embodiment of this application;

FIG. 5 is a diagram of a principle of Huffman encoding according to an embodiment of this application;

FIG. 6 is a diagram of a quantization and encoding process according to an embodiment of this application;

FIG. 7 is a diagram of a quantization and encoding mechanism according to an embodiment of this application;

FIG. 8 is a flowchart of an audio decoding method according to an embodiment of this application;

FIG. 9 is a diagram of a principle of Huffman decoding according to an embodiment of this application;

FIG. 10 is a diagram of a structure of an audio encoding apparatus according to an embodiment of this application;

FIG. 11 is a diagram of a structure of an audio decoding apparatus according to an embodiment of this application; and

FIG. 12 is a diagram of a structure of an electronic device according to an embodiment of this application.

### DESCRIPTION OF EMBODIMENTS

To make objectives, technical solutions, and advantages of embodiments of this application clearer, the following further describes implementations of this application in detail with reference to the accompanying drawings.

First, an implementation environment and background knowledge related to embodiments of this application are described.

As wireless Bluetooth devices such as true wireless stereo (TWS) headsets, smart speakers, and smartwatches are widely popularized and used in people's daily life, people's requirements for high-quality audio playing experience in various scenarios become increasingly urgent, especially in environments in which Bluetooth signals are vulnerable to interference, for example, subways, airports, and railway stations. In a Bluetooth interconnection scenario, due to a limit of a Bluetooth channel connecting an audio sending device and an audio receiving device on a data transmission size, when an audio signal is transmitted, to reduce a bandwidth occupied when the audio signal is transmitted, an audio encoder in the audio sending device is usually configured to encode the audio signal, and then an encoded audio signal is transmitted to the audio receiving device. After receiving the encoded audio signal, the audio receiving device needs to decode the encoded audio signal by using an audio decoder in the audio receiving device, and then plays a decoded audio signal. It can be learned that, while the wireless Bluetooth devices are popularized, various Bluetooth audio codecs are also promoted to flourish.

Currently, Bluetooth audio codecs include a sub-band encoder (SBC), a Bluetooth advanced audio encoder (advanced audio coding, AAC) series (for example, AAC-LC, AAC-LD, AAC-HE, and AAC-HEv2) of the moving picture experts group (MPEG), an aptX series (for example, aptX, aptX HD, and aptX low-latency) encoder, a low-latency high-definition audio codec (LHDC), a low-energy low-latency LC3 audio codec, an LC3plus, and the like.

It should be understood that an audio encoding method and an audio decoding method provided in embodiments of this application may be applied to the audio sending device (namely, an encoder side) and the audio receiving device (namely, a decoder side) in the Bluetooth interconnection scenario. Certainly, in an actual application, the method may be further applied to another short-range transmission scenario. In embodiments of this application, the Bluetooth interconnection scenario is used as an example for description.

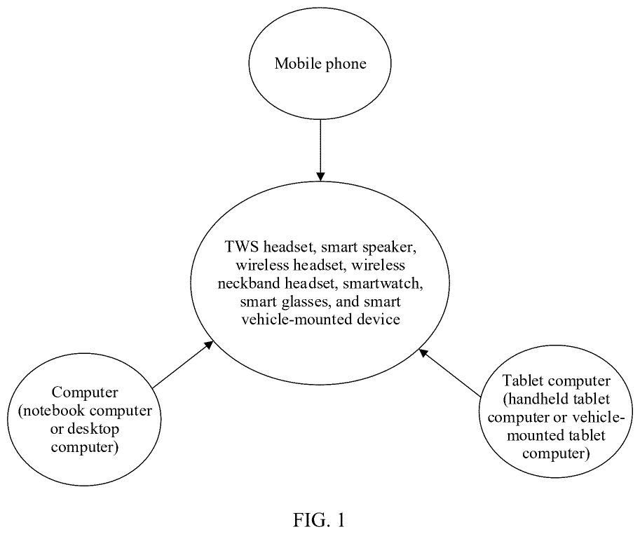

FIG. 1 is a diagram of a Bluetooth interconnection scenario according to an embodiment of this application. As shown in FIG. 1, the Bluetooth interconnection scenario includes an audio sending device and an audio receiving device. An audio encoder is configured for the audio sending device. An audio decoder is configured for the audio receiving device. The audio sending device may be a mobile phone, a computer, a tablet computer, or the like. The computer may be a notebook computer, a desktop computer, or the like, and the tablet computer may be a handheld tablet computer, a vehicle-mounted tablet computer, or the like. The audio receiving device may be a TWS headset, a smart speaker, a wireless headset, a wireless neckband headset, a smartwatch, smart glasses, a smart vehicle-mounted device, or the like. In some other embodiments, the audio receiving device in the Bluetooth interconnection scenario may alternatively be a mobile phone, a computer, a tablet computer, or the like.

It should be noted that, in addition to the Bluetooth interconnection scenario, the audio encoding method and the audio decoding method provided in embodiments of this application may be applied to another device interconnection scenario. In other words, a system architecture and a service scenario that are described in embodiments of this application are intended to describe the technical solutions in embodiments of this application more clearly, and do not constitute a limitation on the technical solutions provided in embodiments of this application. A person of ordinary skill in the art may learn that the technical solutions provided in embodiments of this application are also applicable to a similar technical problem as the system architecture evolves and a new service scenario emerges.

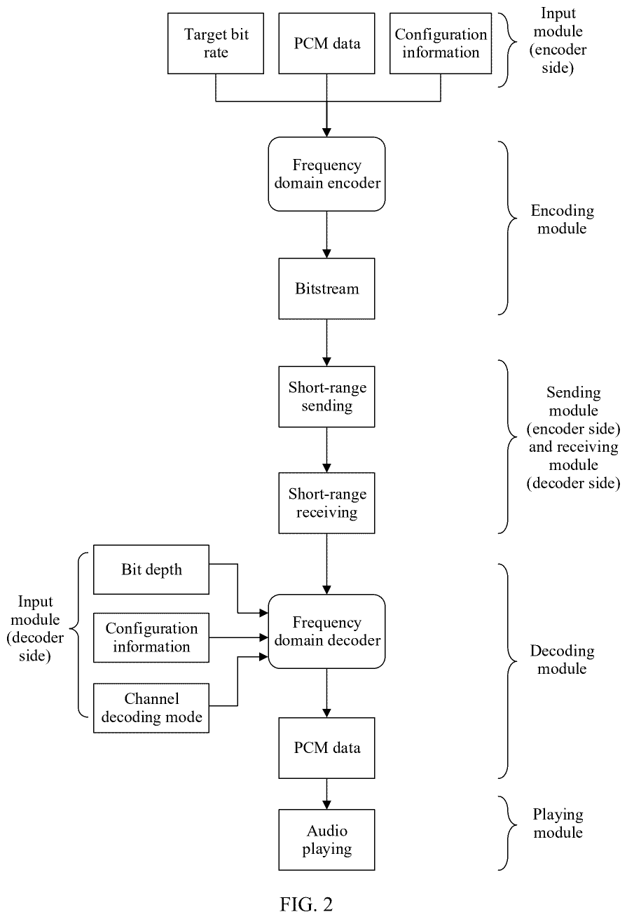

FIG. 2 is a diagram of a system architecture related to an audio signal processing method according to an embodiment of this application. As shown in FIG. 2, the system includes an encoder side and a decoder side. The encoder side includes an input module, an encoding module, and a sending module. The decoder side includes a receiving module, an input module, a decoding module, and a playing module.

On the encoder side, a user further needs to provide a to-be-encoded audio signal (pulse code modulation (PCM) data shown in FIG. 2) to the encoder side. In addition, the user further needs to set a target bit rate of a bitstream obtained through encoding, namely, an encoding bit rate of the audio signal. A higher target bit rate indicates better sound quality, but poorer anti-interference performance of a bitstream in a short-range transmission process. A lower target bit rate indicates poorer sound quality, but better anti-interference performance of the bitstream in the short-range transmission process.

In addition, the user needs to set other configuration information such as an encoding mode, a frame length, and delay information. This embodiment of this application may provide two encoding modes. The two encoding modes are a low-delay encoding mode and a high-sound quality encoding mode. The user determines one encoding mode from the two encoding modes based on a use scenario. For example, if the use scenario is playing a game, live streaming, calling, or the like, the user may select the low-delay encoding mode; and if the use scenario is enjoying music by using a headset or a speaker, or the like, the user may select the high-sound quality encoding mode. The frame length is a length of one frame of audio signal, and can be measured by time. For example, for the two encoding modes, a frame length of the low-delay encoding mode is 5 milliseconds (ms), and a frame length of the high-sound quality encoding mode is 10 ms. The delay information is whether to use low-delay transform when the audio signal is encoded.

In short, the input module of the encoder side obtains the target bit rate, the to-be-encoded audio signal, and the other configuration information that are submitted by the user. After obtaining data submitted by the user, the input module of the encoder side inputs, into a frequency domain encoder of the encoding module, the data submitted by the user.

The frequency domain encoder of the encoding module performs encoding based on the received data, to obtain the bitstream. The frequency domain encoder analyzes the to-be-encoded audio signal, to obtain a signal feature (including a single-channel/dual-channel signal, a stable/non-stable signal, a full-bandwidth/narrow-bandwidth signal, and the like). The audio signal enters a corresponding encoding processing submodule based on the signal feature and a bit rate level (namely, the target bit rate). The encoding processing submodule encodes the audio signal, and packages a header (including a sampling rate, a quantity of channels, the encoding mode, the frame length, and the like) of the bitstream, to finally obtain the bitstream.

The sending module of the encoder side sends the bitstream to the decoder side. For example, the sending module modulates a bitstream of a digital signal into an analog signal, and then transmits a radio wave through an antenna. Optionally, the sending module is a short-range sending module shown in FIG. 2 or another type of sending module. The short-range sending module may be Bluetooth or a wireless network. This is not limited in this embodiment of this application.

On the decoder side, the receiving module of the decoder side receives the bitstream, sends the bitstream to a frequency domain decoder of the decoding module, and notifies the input module of the decoder side to obtain a configured bit depth, configured configuration information, a configured channel decoding mode, and the like of the audio signal. For example, the receiving module receives the analog signal through the radio wave, and then demodulates the analog signal into the bitstream of the digital signal. Optionally, the receiving module is a short-range receiving module shown in FIG. 2 or another type of receiving module. The short-range sending module may be Bluetooth or a wireless network. This is not limited in this embodiment of this application.

The input module of the decoder side inputs the information such as the bit depth, the configuration information, and the channel decoding mode of the audio signal into the frequency domain decoder of the decoding module.

The frequency domain decoder of the decoding module parses the bitstream based on the bit depth, the configuration information, the channel decoding mode, and the like of the audio signal, to obtain required audio data (the PCM data shown in FIG. 2), and sends the obtained audio data to the playing module. The playing module plays audio. The channel decoding mode indicates a channel that needs to be decoded, and the channel decoding mode may be indicated by a flag bit. The flag bit may be a first value, a second value, or a third value, the first value indicates a left-channel output, the second value indicates a right-channel value, and the third value indicates a stereo output. For example, the first value is 0, the second value is 1, and the third value is 2.

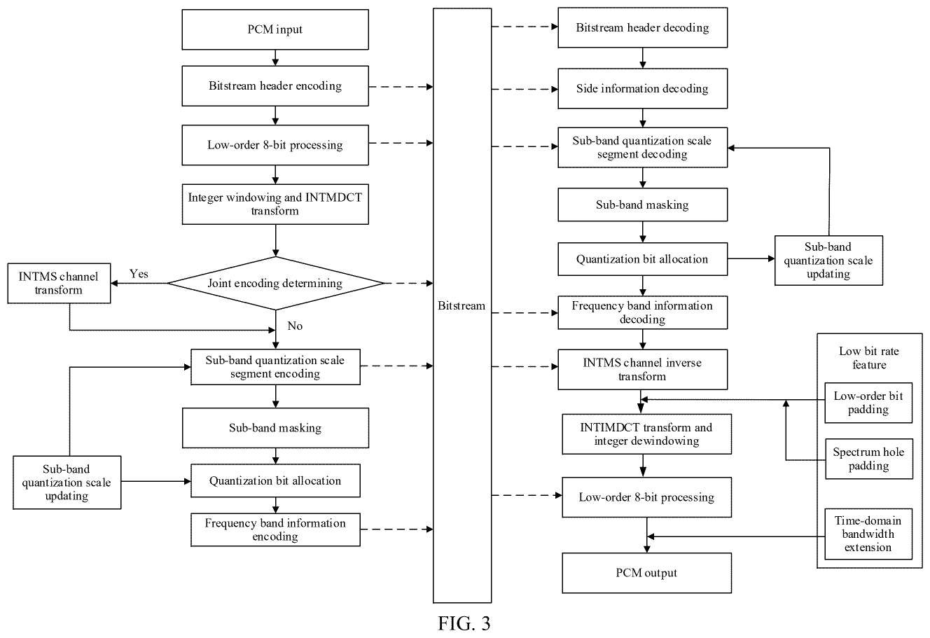

The following describes in detail an encoding part and a decoding part in the system architecture shown in FIG. 2. FIG. 3 is a diagram of an overall framework of audio encoding/decoding according to an embodiment of this application. In FIG. 3, there are two types of data streams. One is a control data stream (shown by a solid line), namely, a data stream obtained by performing a series of algorithm processing after an audio signal enters a frequency domain encoder and a bitstream enters a frequency domain decoder. The other is an encoded data stream (shown by a dashed line), namely, a data part that needs to be encoded into a bitstream and on which wireless transmission is performed, and a data stream that needs to be parsed by a decoder side.

The encoding part includes the following modules:

### (1) PCM Input Module

PCM data is input. The PCM data is single-channel data, dual-channel data, or multi-channel data. A bit depth of the PCM data may be a 16-bit, 24-bit, or 32-bit floating point, or a 32-bit fixed point. A supported sampling rate may be 44.1 kilohertz (kHz), 48 kHz, 88.2 kHz, 96 kHz, or the like. Optionally, the PCM input module transforms the input PCM data into a same bit depth, for example, a bit depth of 24 bits, performs deinterleaving on the PCM data, and then places the deinterleaved PCM data on each channel.

### (2) Bitstream Header Encoding Module

A sampling rate (for example, 44.1 kHz/48 kHz/88.2 kHz/96 kHz), a quantity of channels (for example, a single channel and dual channels), a bit depth, a frame length (for example, 5 ms and 10 ms), an encoding mode (for example, a time domain, a frequency domain, a time domain-to-frequency domain switching mode, or a frequency domain-to-time domain switching mode) of the PCM data are encoded into a bitstream.

### (3) Low-Order 8-Bit Processing Module

Whether low-order 8 bits of the PCM data are all 0s is detected. If the low-order 8 bits of the PCM data are all 0s, the sampling rate of the PCM data is shifted rightward by 8 bits; or if the low-order 8 bits of the PCM data are not all 0s, the sampling rate of the PCM data remains unchanged. Then, a flag bit indicating whether the sampling rate of the PCM data is shifted is encoded into the bitstream.

In some cases, a 16-bit sound source is transformed into a 24-bit sound source, a 24-bit sound source is transformed into a 32-bit sound source, or a 16-bit sound source is transformed into a 32-bit sound source. Therefore, a compression rate can be effectively improved after the sampling rate of the PCM data is shifted.

### (4) Integer Windowing and INTMDCT Transform Module

After integer windowing and INTMDCT transform are performed on PCM data obtained through processing performed by the module (3), spectrum data of an INTMDCT domain, namely, a spectrum of each frame of audio signal is obtained. Windowing is to prevent spectrum leakage.

INTMDCT is similar to MDCT, and includes two main processes: windowing and folding, and DCT (namely, DCT-IV) transform of a fourth type. A windowing and folding process of INTMDCT is different from that of MDCT, and DCT-IV transform is also integer time-frequency transform. Both input PCM data and an output spectrum of INTMDCT are integers. Inverse transform (namely, integer inverse modified discrete cosine transform (INTIMDCT)) can restore an integer spectrum to integer PCM data, which is completely bit-consistent with the input PCM data, only except for a sequence delay of several points, which is different from MDCT transform that has a floating point calculation error.

### (5) INTMS Channel Transform Module

INTMS channel transform is integer middle/side (INTMS) channel transform, and may also be referred to as integer middle/side stereo transform (integer mid/side stereo transform coding, INTMS transform for short).

The spectrum of each frame of audio data determined by the module (4) is a spectrum of a left/right (LR) channel. In this case, the spectrum of the LR channel is divided into sub-bands, to determine a sum of sub-band quantization scales of the LR channel, namely, a sum of quantization scales of all sub-bands of the LR channel. The quantization scale is a quantity of bits required for encoding frequency band information with a maximum amplitude in a corresponding sub-band. In addition, the spectrum of the LR channel is transformed into a spectrum of an MS channel, and the spectrum of the MS channel is divided into sub-bands, to determine a sum of sub-band quantization scales of the MS channel, namely, a sum of quantization scales of all sub-bands of the MS channel. If the sum of quantization scales of the MS channel is less than the sum of quantization scales of the LR channel, INTMS transform is performed on the spectrum of the LR channel.

It should be noted that the INTMS channel transform is for dual-channel PCM data. To be specific, for the dual-channel PCM data, after spectrum data is calculated by the module (4), joint encoding determining is performed based on the sum of quantization scales of the LR channel and the sum of quantization scales of the MS channel, to determine whether to perform INTMS channel transform on left/right-channel data. INTMS transform may not be performed for a single channel and a plurality of channels greater than dual channels.

After joint determining is performed, a flag bit indicating whether to perform INTMS channel transform may be further encoded into the bitstream.

### (6) Sub-Band Quantization Scale Segment Encoding Module

For a frame of audio signal obtained through processing performed by the module (5), in this embodiment of this application, hierarchical quantization and encoding are performed on a sub-band included in a spectrum of the frame of audio signal, or a plurality of times of cyclic quantization and encoding are performed. To be specific, a plurality of sub-bands included in the spectrum are classified into a plurality of parts, and sub-bands of two adjacent parts may overlap or may not overlap. After quantization and encoding are performed on a part of sub-bands, quantization and encoding are performed on a next part of sub-bands. Therefore, a maximum bandwidth that is currently allowed to be encoded and a corresponding sub-band may be determined based on information such as a quantity of currently used bits, a quantity of channels, and a quantity of sampling points, and these sub-bands are used as current to-be-encoded sub-bands. Then, sub-bands whose quantization scales are not encoded in the current to-be-encoded sub-bands are determined, and the quantization scales of these sub-bands are encoded into the bitstream.

### (7) Sub-band Masking Module

For the current to-be-encoded sub-bands determined by the module (6), sub-band masking is performed on quantization scales of the current to-be-encoded sub-bands by using an adjacent sub-band in a psychoacoustic masking manner, to obtain quantization scales obtained through sub-band masking.

(8) Quantization Bit Allocation Module

The quantization scales obtained by performing sub-band masking calculation by the module (7) are scaled to fall within a quantization step, and then, quantization bits are allocated to all the current to-be-encoded sub-bands based on the scaled quantization scales.

For each cycle, the quantization step may be the same or may be different.

### (9) Sub-Band Quantization Scale Updating Module

After the quantization bits are allocated to all the current to-be-encoded sub-bands by the module (8), remaining quantization scales of the sub-bands are updated based on the quantization bits allocated to the sub-bands, and a next cycle is entered.

### (10) Frequency Band Information Encoding Module

After the quantization bits are allocated to all the current to-be-encoded sub-bands by the module (8), frequency band information in the sub-bands is encoded into the bitstream in an entropy encoding or binary encoding manner based on the quantization bits allocated to all the sub-bands.

Entropy encoding may be Hoffman encoding, or certainly, may be another encoding manner.

The decoding part includes the following modules:

### (1) Bitstream Header Parsing Module

Header information is parsed out from the received bitstream. The header information includes information such as the sampling rate, channel information, the frame length, and the encoding mode of the audio signal, and a target bit rate, namely, an encoding bit rate, or referred to as bit rate level information, is calculated based on a bitstream size, the sampling rate, the frame length, and the like.

### (2) Side Information Decoding Module

Side information is obtained through decoding from the bitstream, including information such as a flag bit indicating whether the sampling rate of the PCM data is shifted, a flag bit indicating whether to perform INTMS channel transform, or the quantization step, and other configuration information.

### (3) Sub-Band Quantization Scale Segment Decoding Module

When an encoder side performs hierarchical quantization and encoding or cyclic quantization and encoding, the decoder side also performs hierarchical decoding or cyclic decoding. To be specific, a maximum bandwidth that is currently allowed to be decoded and a corresponding sub-band may be calculated based on the information such as the quantity of currently used bits, the quantity of channels, and the quantity of sampling points, and these sub-bands are used as current to-be-decoded sub-bands. Then, sub-bands whose quantization scales are not decoded in the current to-be-decoded sub-bands are determined, and the quantization scales of these sub-bands are parsed out from the bitstream.

### (4) Sub-Band Masking Module

For the current to-be-decoded sub-bands determined by the module (3), sub-band masking is performed on quantization scales of the current to-be-decoded sub-bands by using an adjacent sub-band in a psychoacoustic masking manner, to obtain quantization scales obtained through sub-band masking.

### (5) Quantization Bit Allocation Module

The quantization scales obtained by performing sub-band masking calculation by the module (4) are scaled to fall within a quantization step, and then, quantization bits are allocated to all the current to-be-decoded sub-bands based on the scaled quantization scales.

For each cycle, the quantization step may be the same or may be different.

### (6) Sub-Band Quantization Scale Updating Module

After the quantization bits are allocated to all the current to-be-decoded sub-bands by the module (5), remaining quantization scales of the sub-bands are updated based on the quantization bits allocated to the sub-bands, and a next cycle is entered.

### (7) Frequency Band Information Decoding Module

After the quantization bits are allocated to all the current to-be-decoded sub-bands by the module (5), frequency band information in the sub-bands is parsed out from the bitstream in an entropy decoding or binary decoding manner based on the quantization bits allocated to all the sub-bands.

Entropy decoding may be Hoffman decoding, or certainly, may be another decoding manner.

### (8) INTMS Channel Inverse Transform Module

After the spectrum data is parsed out by the module (7), whether to perform INTMS channel inverse transform is determined based on the flag bit that indicates whether to perform INTMS channel transform and that is parsed out from the bitstream by the module (2). If INTMS channel inverse transform needs to be performed, INTMS channel inverse transform is performed on the parsed out spectral data, to obtain spectral data of the LR channel.

The INTMS channel inverse transform is also referred to as an integer middle/side (INTIMS) channel transform, or an integer inverse middle/side stereo transform (integer inverse mid/side stereo transform coding, INTIMS transform for short).

### (9) INTIMDCT Transform and Integer Dewindowing Module

INTIMDCT transform and integer dewindowing are performed on the spectrum data that is of the LR channel and that is obtained by the module (8), to obtain the PCM data.

INTIMDCT is similar to IMDCT, and includes two main processes: DCT-IV transform and unfolding during dewindowing. However, DCT-IV transform and dewindowing and unfolding processes of INTIMDCT are different from those of IMDCT. An input spectrum and output PCM of INTIMDCT are integers.

### (10) Low-Order 8-Bit Processing Module

Whether to shift, leftward by 8 bits, a sampling point value of the PCM data obtained by the module (9) is determined based on the flag bit indicating whether the sampling rate of the PCM data parsed out from the bitstream by the module (2) is shifted.

### (11) PCM Output Module

PCM data of a corresponding channel is output based on a configured bit depth and channel decoding mode.

### (12) Low Bit Rate Feature Module

The decoder side provides some optional modules for decoding in a lossy state, to improve sound quality. Low-order bit padding is performed on frequency band information from which a high-order bit is obtained through decoding but a low-order bit is not obtained through decoding. The low-order bit that is not obtained through decoding is padded in a form of a random bit. Spectrum hole padding is performed on frequency band information whose sub-band quantization scale is not zero but a value obtained through decoding is zero, and a random number is generated based on the sub-band quantization scale for replacement. Time-domain bandwidth extension is to extend a bandwidth of the output PCM to a full band.

It should be noted that the audio encoding and decoding framework shown in FIG. 3 is merely used as an example of a terminal in embodiments of this application, and is not intended to limit embodiments of this application. A person skilled in the art may obtain another encoding and decoding framework on the basis of FIG. 3.

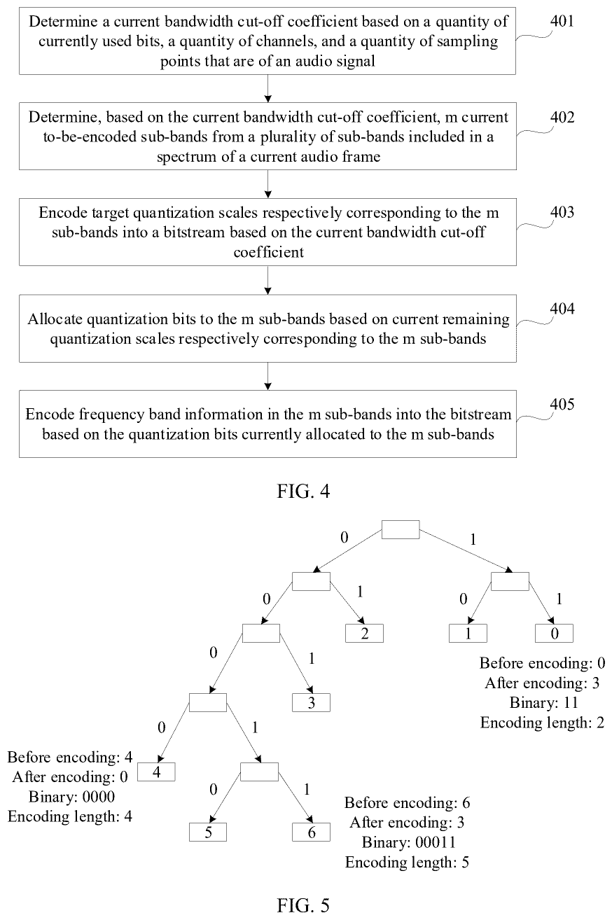

The following describes a quantization and encoding process provided in an embodiment of this application. FIG. 4 is a flowchart of an audio encoding method according to an embodiment of this application. The method is applied to an encoder side. As shown in FIG. 4, the method includes the following steps.

Step 401: Determine a current bandwidth cut-off coefficient based on a quantity of currently used bits, a quantity of channels, and a quantity of sampling points that are of an audio signal, where the quantity of currently used bits is a quantity of bits consumed by encoding a spectrum of a current audio frame of the audio signal before current time.

Based on the foregoing description, in this embodiment of this application, hierarchical quantization and encoding may be performed on a sub-band included in the spectrum of the current audio frame of the audio signal, or a plurality of times of cyclic quantization and encoding may be performed. A high bandwidth is not necessarily encoded at a low bit rate, and a higher bandwidth may be encoded only at a specific bit rate. In other words, frequency band information in all sub-bands is not necessarily encoded at the low bit rate, and only frequency band information in some sub-bands may need to be encoded. Therefore, in each cycle of hierarchical quantization, a maximum bandwidth allowed to be encoded in a case of the quantity of currently used bits, namely, a current to-be-encoded maximum sub-band, may be determined. The current to-be-encoded maximum sub-band may be determined based on the current bandwidth cut-off coefficient.

In some embodiments, the current bandwidth cut-off coefficient may be determined based on the quantity of currently used bits, the quantity of channels, and the quantity of sampling points that are of the audio signal and Formula (1):

$$cutOffRatio = bandLimitCoef * \sqrt{\frac{bitCount}{nChannel * frameLen}} \qquad ( 1 )$$

In Formula (1), cutOffRatio represents the current bandwidth cut-off coefficient, bandLimitCoef represents an adjustment parameter of the current bandwidth cut-off coefficient, and is a constant, bitCount represents the quantity of currently used bits, nChannel represents the quantity of channels of the audio signal, and frameLen represents the quantity of sampling points of the audio signal.

It should be noted that a quantization and encoding process is performed for audio frames one by one. The encoder side can perform quantization and encoding on each audio frame according to this solution. A spectrum of the audio signal is a spectrum obtained after windowing and folding transform are performed on an audio frame. The quantity of sampling points of the audio signal is a quantity of sampling points included in an audio frame.

The current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists.

Step 402: Determine, based on the current bandwidth cut-off coefficient, m current to-be-encoded sub-bands from a plurality of sub-bands included in the spectrum of the current audio frame, where m is greater than or equal to 1 and less than or equal to a total quantity of the plurality of sub-bands.

In some embodiments, the current bandwidth cut-off coefficient may be multiplied by the quantity of sampling points of the audio signal, to obtain a current cut-off frequency. A sub-band in which the current cut-off frequency is located is determined from the plurality of sub-bands included in the spectrum of the current audio frame, and then a sub-band before the sub-band in which the current cut-off frequency is located in the plurality of sub-bands is determined as the m current to-be-encoded sub-bands.

It should be noted that, in each quantization cycle, the current bandwidth cut-off coefficient dynamically changes. In this way, values of m determined based on the current bandwidth cut-off coefficient may be different.

In addition, the m current to-be-encoded sub-bands may include the sub-band in which the current cut-off frequency is located, or may not include the sub-band in which the current cut-off frequency is located. This is not limited in this embodiment of this application.

Step 403: Encode target quantization scales respectively corresponding to the m sub-bands into a bitstream based on the current bandwidth cut-off coefficient, where the target quantization scale is a quantity of bits required for encoding frequency band information with a largest amplitude in a corresponding sub-band.

Based on the foregoing descriptions, the current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists. In a case of the full band and the non-full band, the target quantization scales respectively corresponding to the m sub-bands are encoded into the bitstream in different manners, which are separately described below.

In a first case, when the current bandwidth cut-off coefficient indicates the non-full band, a difference between target quantization scales of every two adjacent sub-bands in the m sub-bands is determined, to obtain m-1 quantization scale differences; a smallest value and a largest value in the m-1 quantization scale differences are determined; and the target quantization scales respectively corresponding to the m sub-bands are encoded into the bitstream in a differential encoding manner if the smallest value is greater than a first threshold and the largest value is less than a second threshold.

When the current bandwidth cut-off coefficient indicates the non-full band, it indicates that the target quantization scales respectively corresponding to the m sub-bands further include a target quantization scale that is not encoded into the bitstream. That is, encoding of the target quantization scales respectively corresponding to the m sub-bands is not completed. In this case, the target quantization scales respectively corresponding to the m sub-bands may be encoded into the bitstream in the foregoing manner.

A manner of determining the difference between the target quantization scales of every two adjacent sub-bands in the m sub-bands may be represented by using Formula (2), a manner of determining the smallest value and the largest value in the m-1 quantization scale differences may be represented by using Formula (3) and Formula (4), and whether a differential encoding manner is used may be represented by using Expression (5):

$$bandQsTmp [ b ] = bandQs [ b ] - bandQs [ b - 1 ] , b = 1 , 2 , … , nband \qquad ( 2 )$$

$$bandQsMin = Min ( bandQsTmp [ b ] , b = 1 , 2 , … , nband ) \qquad ( 3 )$$

$$bandQsMax = Max ( bandQsTmp [ b ] , b = 1 , 2 , … , nband ) \qquad ( 4 )$$

$$bandQsDiff = True if ( bandQsMin > H 1 and bandQsMax < H 2 ) else False \qquad ( 5 )$$

In the foregoing formulas, bandQsTmp[b] represents a quantization scale difference, bandQs[b] represents a target quantization scale of a b^{th} sub-band, bandQs[b-1] represents a target quantization scale of a (b-1)^{th} sub-band, nband represents a total quantity of the m sub-bands, bandQsMin represents the smallest value in the m-1 quantization scale differences, bandQsMax represents the largest value in the m-1 quantization scale differences, bandQsDiff represents that the differential encoding manner is used, H1 represents the first threshold, and H2 represents the second threshold.

It should be noted that the first threshold and the second threshold are obtained in advance through statistics collection. For example, the first threshold is −5, and the second threshold is 5. In different cases, values of the first threshold and the second threshold may be different.

In some embodiments, an implementation process in which the target quantization scales respectively corresponding to the m sub-bands are encoded into the bitstream in the differential encoding manner includes: For a 1^{st} sub-band in the m sub-bands, a target quantization scale of the 1^{st} sub-band in the m sub-bands is encoded into the bitstream in a non-differential entropy encoding manner. For a non-1^{st} sub-band in the m sub-bands, a target quantization scale of an adjacent previous sub-band is subtracted from a target quantization scale of the sub-band, to obtain a quantization scale difference. The quantization scale difference is encoded into the bitstream in the entropy encoding manner.

Optionally, the target quantization scales respectively corresponding to the m sub-bands are encoded into the bitstream in the non-differential encoding manner if the smallest value is not greater than the first threshold or the largest value is not less than the second threshold. That is, a target quantization scale of each of the m sub-bands is directly encoded into the bitstream in the entropy encoding manner.

It should be noted that the entropy encoding may be Huffman encoding, or may be another encoding manner. This is not limited in this embodiment of this application. In addition, an encoder side may further encode an encoding manner of the m sub-bands into the bitstream, that is, whether the m sub-bands are encoded in the differential encoding manner or the non-differential encoding manner.

When entropy encoding is Huffman encoding, an encoding codebook used in the non-differential entropy encoding manner is shown as follows:

{{0, 244, 8}, {1, 245, 8}, {2, 246, 8}, {3, 247, 8}, {4, 248, 8}, {5, 249, 8};
{6, 250, 8}, {7, 251, 8}, {8, 252, 8}, {9, 116, 7}, {10, 117, 7}, {11, 118, 7};
{12, 56, 6}, {13, 24, 5}, {14, 25, 5}, {15, 26, 5}, {16, 8, 4}, {17, 9, 4};
{18, 10, 4}, {19, 0, 3}, {20, 1, 3}, {21, 2, 3}, {22, 3, 3}, {23, 11, 4};
{24, 27, 5}, {25, 57, 6}, {26, 119, 7}, {27, 253, 8}, {28, 254, 8}, {29, 120, 7}; and
{30, 121, 7}, {31, 255, 8}}.

When entropy encoding is Huffman encoding, an encoding codebook used in the differential entropy encoding manner is shown as follows:

{{0, 124, 7}, {1, 50, 6}, {2, 63, 6}, {3, 30, 5}, {4, 5, 4}, {5, 13, 4};
{6, 0, 3}, {7, 3, 3}, {8, 5, 3}, {9, 4, 3}, {10, 1, 3}, {11, 14, 4}; and
{12, 4, 4}, {13, 24, 5}, {14, 51, 6}, {15, 125, 7}}.

In a second case, when the current bandwidth cut-off coefficient indicates the full band, the target quantization scales respectively corresponding to the m sub-bands do not need to be encoded into the bitstream.

When the current bandwidth cut-off coefficient indicates the full band, it indicates that the target quantization scales respectively corresponding to the m sub-bands are encoded into the bitstream. In this case, the target quantization scales respectively corresponding to the m sub-bands do not need to be encoded into the bitstream.

In some embodiments, the target quantization scales respectively corresponding to the m sub-bands may be further determined before the target quantization scales respectively corresponding to the m sub-bands are encoded into the bitstream based on the current bandwidth cut-off coefficient.

For example, for any one of the m sub-bands, a target quantization scale of the sub-band may be determined based on frequency band information with a maximum amplitude in the sub-band and Formula (6):

$$bandQ {s}_{b} = ⌈ {log}_{2} ( {f}_{max} + 1.0 ) ⌉ \qquad ( 6 )$$

In Formula (6), bandQsp represents the target quantization scale of the b^{th} sub-band, and fₘₐₓ represents a maximum amplitude of frequency band information in the b^{th} sub-band, and is a positive number.

For 24-bit PCM data, after time-frequency transform is performed on the PCM data, a quantity of bits required for encoding each piece of frequency band information in a spectrum corresponding to the PCM data is usually within a range of 0 to 31.

It should be noted that one sub-band includes a plurality of frequency bands, each frequency band has one piece of corresponding frequency band information, and the frequency band information represents the corresponding frequency band. The frequency band information may include an amplitude and a positive/negative sign of the amplitude. In other words, a value of the frequency band information may include a positive number, or may include a negative number. When the frequency band information is encoded into the bitstream, the amplitude and the positive/negative sign included in the frequency band information may be encoded into the bitstream. In addition, usually, the amplitude and the positive/negative sign included in each piece of frequency band information are encoded separately.

Step 404: Allocate quantization bits to the m sub-bands based on current remaining quantization scales respectively corresponding to the m sub-bands, where the current remaining quantization scale is an unallocated quantization scale remaining after a quantization bit is allocated to a corresponding sub-band last time.

When the current remaining quantization scales respectively corresponding to the m sub-bands are different, the quantization bits are allocated to the m sub-bands in different manners, which are separately described below.

In a first case, when the current remaining quantization scales respectively corresponding to the m sub-bands are all 0s, a quantization and encoding cycle of the spectrum of the audio signal ends.

When the current remaining quantization scales respectively corresponding to the m sub-bands are all 0s, it indicates that the plurality of sub-bands included in the spectrum of the audio signal are all encoded into the bitstream. In this case, a quantization and encoding cycle of the plurality of sub-bands may be ended, and a quantization and encoding cycle of a sub-band included in a next spectrum is performed.

In a second case, the quantization bits are allocated to the m sub-bands based on the current remaining quantization scales respectively corresponding to the m sub-bands when the current remaining quantization scales respectively corresponding to the m sub-bands are not all 0s and are all less than a quantization step.

When the current remaining quantization scales respectively corresponding to the m sub-bands are not all 0s, it indicates that the m sub-bands further include a sub-band whose encoding is not completed in the m sub-bands. Therefore, the quantization bits further need to be allocated to the m sub-bands. When the current remaining quantization scales respectively corresponding to the m sub-bands are all less than a quantization step, it indicates that the quantization bits respectively corresponding to the m sub-bands are all within a range of the quantization step. Therefore, the current remaining quantization scales respectively corresponding to the m sub-bands may be directly used as the quantization bits allocated to the m sub-bands.

It should be noted that, for different quantization and encoding cycles, quantization steps corresponding to all the quantization and encoding cycles may be the same or may be different. This is not limited in this embodiment of this application.

In a third case, when a current remaining quantization scale of at least one of the m sub-bands is greater than a quantization step, psychoacoustic masking is performed on the current remaining quantization scales respectively corresponding to the m sub-bands, to obtain masked remaining quantization scales respectively corresponding to the m sub-bands; the masked remaining quantization scales respectively corresponding to the m sub-bands are scaled based on the quantization step, to obtain scaled remaining quantization scales respectively corresponding to the m sub-bands; and the quantization bits are allocated to the m sub-bands based on the scaled remaining quantization scales respectively corresponding to the m sub-bands and the target quantization scales respectively corresponding to the m sub-bands.

When the current remaining quantization scale of the at least one of the m sub-bands is greater than the quantization step, it indicates that quantization bits of some of the m sub-bands are not within a range of the quantization step. Therefore, the remaining quantization scales respectively corresponding to the m sub-bands need to be processed in a psychoacoustic masking manner, to distinguish importance degrees of the m sub-bands.

In some embodiments, a largest value in the masked quantization scales respectively corresponding to the m sub-bands may be determined, and the masked remaining quantization scales respectively corresponding to the m sub-bands are scaled based on the masked quantization scales respectively corresponding to the m sub-bands, the largest value in the masked quantization scales respectively corresponding to the m sub-bands, and the quantization step, to obtain the scaled remaining quantization scales respectively corresponding to the m sub-bands.

In an example, the masked remaining quantization scales respectively corresponding to the m sub-bands are scaled based on the masked quantization scales respectively corresponding to the m sub-bands, the largest value in the masked quantization scales respectively corresponding to the m sub-bands, and the quantization step and Formula (7):

$$Q [ b ] = Max ( bandQs [ b ] - Qmax + Qs , 0 ) \qquad ( 7 )$$

In Formula (7), Q[b] represents a scaled remaining quantization scale of the b^{th} sub-band, bandQs[b] represents a masked quantization scale of the b^{th} sub-band, Qmax represents the largest value in the masked quantization scales respectively corresponding to the m sub-bands, and Qs represents the quantization step.

In another example, the masked remaining quantization scales respectively corresponding to the m sub-bands are scaled based on the masked quantization scales respectively corresponding to the m sub-bands, the largest value in the masked quantization scales respectively corresponding to the m sub-bands, and the quantization step and Formula (8):

$$Q [ b ] = Max ( \frac{bandQs [ b ] * Qs}{Q max} , 0 ) \qquad ( 8 )$$

Meanings represented by all letters in Formula (8) are the same as those in Formula (7). Details are not described herein again.

After the scaled remaining quantization scales respectively corresponding to the m sub-bands are determined, for any one of the m sub-bands, a smaller value in a scaled remaining quantization scale and a target quantization scale that are of the sub-band is determined as a quantization bit allocated to the sub-band.

After the quantization bits are allocated to the m sub-bands in the foregoing manner, the remaining quantization scales respectively corresponding to the m sub-bands may be updated. That is, for any one of the m sub-bands, a quantization bit allocated to the sub-band this time is subtracted from a current remaining quantization scale of the sub-band, to obtain an updated remaining quantization scale of the sub-band.

Step 405: Encode frequency band information in the m sub-bands into the bitstream based on the quantization bits currently allocated to the m sub-bands.

Because the plurality of times of cyclic quantization and encoding are performed on the sub-band included in the spectrum of the audio signal, the quantization bits allocated to the m sub-bands based on the current remaining quantization scales respectively corresponding to the m sub-bands may also be referred to as the quantization bits currently allocated to the m sub-bands, or quantization bits allocated to the m sub-bands in a current cycle.

Because hierarchical quantization and encoding are performed on the plurality of sub-bands included in the spectrum of the audio signal, for a same sub-band, hierarchical quantization and encoding may also be performed on frequency band information in the sub-band. In other words, different frequency band information in a same sub-band may be located at different quantization layers. When channels of the sub-band are located at different quantization layers, the frequency band information in the sub-band is encoded into the bitstream in different manners. The following provides descriptions by using any one of the m sub-bands as an example.

In a first case, when a current quantization layer quantity of a target sub-band is less than or equal to a maximum quantization layer quantity, if a quantization bit currently allocated to the target sub-band is 1, frequency band information in the target sub-band is encoded into the bitstream in the entropy encoding manner based on the quantization bit currently allocated to the target sub-band. The target sub-band is any one of the m sub-bands.

The current quantization layer quantity of the target sub-band is a ranking of a quantization and encoding cycle in which the frequency band information in the target sub-band is currently encoded. The maximum quantization layer quantity is preset. In different cases, values of the maximum quantization layer quantity may be different.

An implementation process of encoding the frequency band information in the target sub-band into the bitstream in the entropy encoding manner based on the quantization bit currently allocated to the target sub-band includes: encoding every plurality of bits in the frequency band information in the target sub-band into the bitstream as a group in the entropy encoding manner based on the quantization bit currently allocated to the target sub-band.

In an example, when the current quantization layer of the target sub-band is a first layer and a bandwidth of the target sub-band is greater than 1, every n bits in the frequency band information in the target sub-band are encoded into the bitstream as a group in the entropy encoding manner based on the quantization bit currently allocated to the target sub-band, where n is an integer greater than 1; when the current quantization layer of the target sub-band is a second layer, every k bits in the frequency band information in the target sub-band are encoded into the bitstream as a group in the entropy encoding manner based on the quantization bit currently allocated to the target sub-band, where k is an integer greater than 1; and when the current quantization layer of the target sub-band is greater than or equal to a third layer, every h bits in the frequency band information in the target sub-band are encoded into the bitstream as a group in the entropy encoding manner based on the quantization bit currently allocated to the target sub-band, where h is an integer greater than 1.

In some embodiments, when the current quantization layer of the target sub-band is the first layer and the bandwidth of the target sub-band is 1, it indicates that the value of the frequency band information in the target sub-band is 1, and encoding may not need to be performed.

Values of n, k, and h may be the same, or may be different. For example, n is 4, k is 3, and his 2. The values of n, k, and h may be different when requirements are different. In addition, when a sub-band includes frequency band information that is not grouped, for the frequency band information that is not grouped, the frequency band information may be encoded into the bitstream in a binary encoding manner.

The entropy encoding may be Hoffman encoding. For example, when n is 4, every n bits in the frequency band information in the target sub-band are encoded into the bitstream as a group in the Huffman encoding manner, and a used encoding codebook is shown as follows:

{{0, 1, 1}, {1, 0, 3}, {2, 6, 4}, {3, 22, 6}, {4, 7, 4}, {5, 19, 6};
{6, 21, 6}, {7, 33, 7}, {8, 1, 3}, {9, 18, 6}, {10, 20, 6}, {11, 71, 8}; and
{12, 23, 6}, {13, 32, 7}, {14, 34, 7}, {15, 70, 8}}.

When k is 3, every k bits in the frequency band information in the target sub-band are encoded into the bitstream as a group in the Huffman encoding manner, and a used encoding codebook is shown as follows:

{{0, 0, 1}, {1, 4, 3}, {2, 5, 3}, {3, 30, 5}, {4, 6, 3}, {5, 29, 5}, {6, 31, 5}, {7, 28, 5}}.

When h is 2, every h bits in the frequency band information in the target sub-band are encoded into the bitstream as a group in the Huffman encoding manner, and a used encoding codebook is shown as follows:

{{0, 0, 1}, {1, 7, 3}, {2, 2, 2}, {3, 6, 3}}.

A form of an encoding codebook of Hoffman encoding is AudioHuffCode {value, code, len}, value is a value before encoding, code is a value after encoding, and len is an encoding length, namely, a quantity of bits used to encode code. The encoding codebook may be constructed through training based on experience or big data. Generally, a value that occurs at a high frequency indicates a shorter code length, and a value that occurs at a low frequency indicates a longer code length. As shown in FIG. 5, before encoding, each value needs to be represented by 5 bits on average, a maximum of 5 bits are required for a value after encoding, and a minimum of 2 bits are required for some values. Clearly, a quantity of bits required for each value on average is less than 5 bits. In this way, a compression rate can be greatly improved.

In a second case, when a current quantization layer quantity of a target sub-band is less than or equal to a maximum quantization layer quantity, if a quantization bit currently allocated to the target sub-band is greater than 1, frequency band information in the target sub-band is encoded into the bitstream in a binary encoding manner based on the quantization bit currently allocated to the target sub-band. The target sub-band is any one of the m sub-bands.

In a third case, when a current quantization layer quantity of a target sub-band is greater than a maximum quantization layer quantity, frequency band information in the target sub-band is encoded into the bitstream in the binary encoding manner based on a quantization bit currently allocated to the target sub-band. The target sub-band is any one of the m sub-bands.

In some embodiments, a current encoding bit rate may be further determined in a process of encoding the frequency band information in the m sub-bands into the bitstream. If the current encoding bit rate is equal to a target encoding bit rate, a hierarchical quantization and encoding cycle of the sub-band included in the spectrum of the audio signal may be ended.

In other words, a quantization and encoding cycle of a sub-band of a spectrum may be terminated due to an insufficient bit rate. Therefore, an intermediate state of the quantization and encoding cycle corresponds to a lossy encoding state, and automatic encoding is performed to switch to a lossless state at an enough bit rate. Therefore, the framework may support a great bit rate change range of a codec from a lossy state to the lossless state.

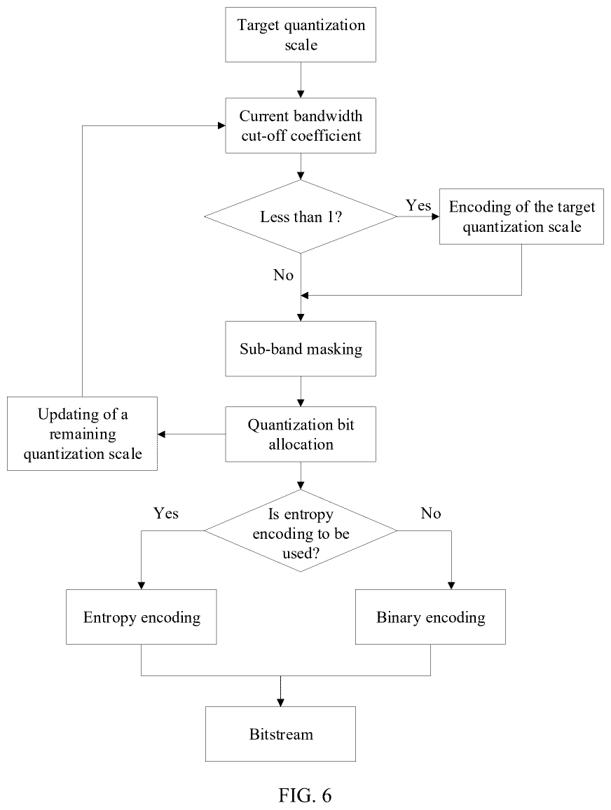

The following describes the quantization and encoding process with reference to FIG. 6. As shown in FIG. 6, after the spectrum of the current audio frame of the audio signal is divided into sub-bands, the target quantization scale of each of the plurality of sub-bands included in the spectrum may be determined; the current bandwidth cut-off coefficient is determined based on the quantity of currently used bits, the quantity of channels, and the quantity of sampling points that are of the audio signal; and the m current to-be-encoded sub-bands are determined from the plurality of sub-bands based on the current bandwidth cut-off coefficient. If the current bandwidth cut-off coefficient is less than 1, the target quantization scales respectively corresponding to the m sub-bands are encoded into the bitstream. If the current bandwidth cut-off coefficient is equal to 1, or after the target quantization scales respectively corresponding to the m sub-bands are encoded into the bitstream, whether sub-band masking needs to be performed on the m sub-bands is determined. After sub-band masking is performed on the m sub-bands, the quantization bits are allocated to the m sub-bands, the remaining quantization scales respectively corresponding to the m sub-bands are updated, and the frequency band information in the m sub-bands is encoded into the bitstream in the entropy encoding manner or the binary encoding manner based on the quantization bits allocated to the m sub-bands.

The foregoing quantization and encoding process has two distinct features. One feature is a quantization and encoding mode in which quantization is performed while encoding is performed. Different from a manner in which most audio codecs separate a quantization process from an encoding process, the feature enables a decoder side to parse out information as much as received information. Therefore, a decoder has a single-frame multi-bit rate feature. To be specific, after an audio frame is encoded, an encoding bit rate of the audio frame may be truncated randomly, so that the audio frame has different bit rates. Another feature is that a quantization and encoding procedure on an encoder side and a quantization and encoding procedure on the decoder side is highly symmetric. That is, the decoder side and the encoder side each have a quantization procedure, which is different from a manner in which quantization of most encoding and decoding is performed on the encoder side, and the decoder side only needs to parse out quantized information. In this solution, quantization bit allocation at each layer on the encoder side is calculated based on a quantity of encoded bits, and correspondingly, quantization bit allocation at each layer on the decoder side is also calculated based on a quantity of decoded bits. In addition, a same quantization bit allocation mechanism is used. Therefore, both the encoder side and the decoder side learn of how to allocate bits in each quantization cycle.

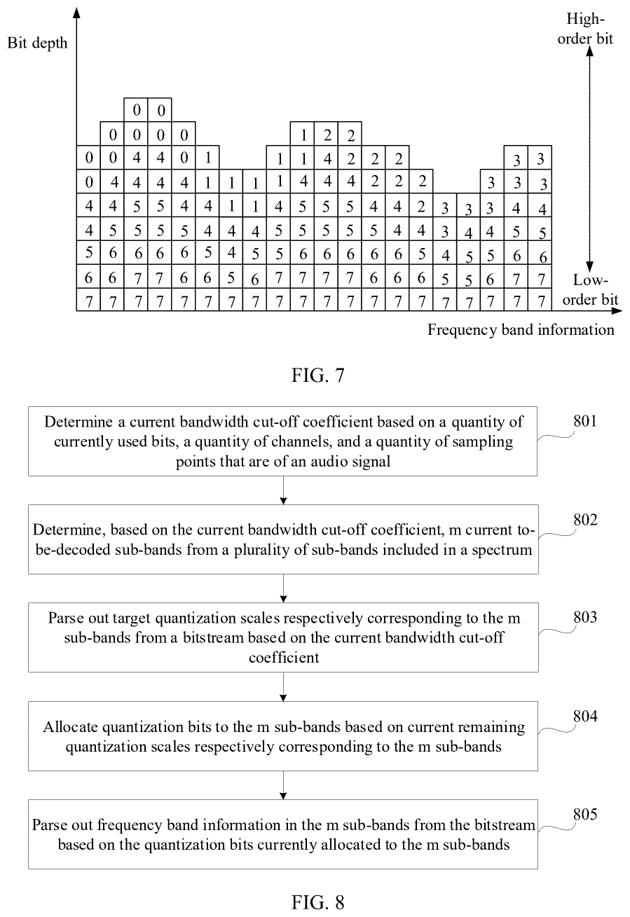

One piece of frequency band information is usually represented by using a plurality of bits. A high-order bit in the plurality of bits is usually closer to a value of the frequency band information, and there is a larger difference between a low-order bit in the plurality of bits and the value of the frequency band information. In addition, in the encoding process, encoding usually starts from the high-order bit in the plurality of bits. Therefore, an importance degree or a priority of the high-order bit in the plurality of bits is higher than that of the low-order bit. That is, the foregoing quantization and encoding mechanism is essentially sorting bits based on importance degrees. As shown in FIG. 7, each column in FIG. 7 is one piece of frequency band information, each small box in a column is one bit, and a smaller number filled in each bit indicates a higher priority of the bit. It can be learned from FIG. 7 that, in a process of performing encoding from left to right, a priority of a high-order bit is higher than a priority of a low-order bit.

Based on the foregoing descriptions, the audio signal may be an audio signal of a single channel, or may be audio signals of dual channels, or may be audio signals of a plurality of channels. In this embodiment of this application, audio signals of all channels may be separately quantized and encoded, or audio signals of all channels may be mixed together for quantization and encoding.

In an example, the audio signal has side information, the side information includes an encoding flag bit, and the audio signal is an audio signal of a single channel when the encoding flag bit is a first value. That is, the audio signals of all the channels are separately quantized and encoded. The audio signal is audio signals of a plurality of channels when the encoding flag bit is a second value. That is, the audio signals of all the channels are mixed together for quantization and encoding.

Such a manner in which the audio signals of all the channels are separately quantized and encoded facilitates separate transmission or decoding of bitstreams of all the channels. In this case, bit rates of all the channels are evenly allocated. Such a manner in which the audio signals of all the channels are mixed for quantization and encoding, hierarchical quantization and encoding are performed channel by channel. In this case, bit rates of all the channels are dynamically allocated, to achieve relatively optimal bit rate allocation. That is, a result of separate quantization and encoding is that bitstreams of all the channels separately support the single-frame multi-bit rate, and a result of mixed quantization and encoding is that a mixed bitstream of all the channels supports the single-frame multi-bit rate.

In this embodiment of this application, hierarchical quantization and encoding are performed on the sub-band included in the spectrum. An insufficient bit rate corresponds to a state of lossy encoding, and an enough bit rate corresponds to a state of lossless encoding. In other words, the quantization and encoding manner provided in this embodiment of this application can support both a lossy encoding feature and a lossless encoding feature, to greatly reduce algorithm complexity and avoid low-efficiency switching between a lossy framework and a lossless framework. In addition, in a process of hierarchical quantization and encoding, quantization is performed while encoding is performed, to randomly truncate an encoded bitstream when a bit rate changes. In other words, an audio frame encoded in this solution has a single-frame multi-bit rate feature. Compared with a manner in which quantization is performed before encoding, this solution can avoid a case in which truncation cannot be performed and encoding needs to be performed again when the bit rate changes, to greatly improve channel adaptive capability in a communication process.

FIG. 8 is a flowchart of an audio decoding method according to an embodiment of this application. The method is applied to a decoder side. As shown in FIG. 8, the method includes the following steps.

Step 801: Determine a current bandwidth cut-off coefficient based on a quantity of currently used bits, a quantity of channels, and a quantity of sampling points that are of an audio signal, where the quantity of currently used bits is a quantity of bits consumed by decoding a spectrum of a current audio frame of the audio signal before current time.

A manner in which the decoder side determines the current bandwidth cut-off coefficient is similar to a manner in which an encoder side determines the current bandwidth cut-off coefficient. For a detailed implementation process, refer to related content in step 401. Details are not described herein again.

Step 802: Determine, based on the current bandwidth cut-off coefficient, m current to-be-decoded sub-bands from a plurality of sub-bands included in the spectrum, where m is greater than or equal to 1 and less than or equal to a total quantity of the plurality of sub-bands.

A manner in which the decoder side determines the m current to-be-decoded sub-bands is similar to a manner in which the encoder side determines the m current to-be-encoded sub-bands. For a detailed implementation process, refer to related content in step 402. Details are not described herein.

Step 803: Parse out target quantization scales respectively corresponding to the m sub-bands from a bitstream based on the current bandwidth cut-off coefficient, where the target quantization scale is a quantity of bits required for encoding frequency band information with a largest amplitude in a corresponding sub-band.

Based on the foregoing descriptions, the current bandwidth cut-off coefficient is usually a value ranging from 0 to 1. When the current bandwidth cut-off coefficient is 1, it indicates that a full band currently exists; or when the current bandwidth cut-off coefficient is less than 1, it indicates that a non-full band currently exists. In a case of the full band and the non-full band, the target quantization scales respectively corresponding to the m sub-bands are encoded into the bitstream in different manners, which are separately described below.

In a first case, when the current bandwidth cut-off coefficient indicates the non-full band, the target quantization scales respectively corresponding to the m sub-bands are parsed out from the bitstream.

When the current bandwidth cut-off coefficient indicates the non-full band, it indicates that the target quantization scales respectively corresponding to the m sub-bands further include a target quantization scale that is not parsed out. That is, parsing of the target quantization scales respectively corresponding to the m sub-bands is not completed. In this case, the target quantization scales respectively corresponding to the m sub-bands may be parsed out from the bitstream.

When the encoder side encodes the target quantization scales respectively corresponding to the m sub-bands into the bitstream in a differential encoding manner, the decoder side may parse out the target quantization scales respectively corresponding to the m sub-bands from the bitstream in a differential decoding manner. When the encoder side encodes the target quantization scales respectively corresponding to the m sub-bands into the bitstream in a non-differential encoding manner, the decoder side may parse out the target quantization scales respectively corresponding to the m sub-bands from the bitstream in a non-differential decoding manner.

An implementation process of parsing out the target quantization scales respectively corresponding to the m sub-bands from the bitstream in the differential decoding manner includes: for a 1^{st} sub-band in the m sub-bands, parsing out a target quantized scale of the 1^{st} sub-band from the bitstream in the non-differential entropy decoding manner. For a non-1^{st} sub-band in the m sub-bands, a quantization scale difference of the sub-band is parsed out from the bitstream in the entropy decoding manner, and then, the quantization scale difference is added to a target quantization scale of an adjacent previous sub-band, to obtain a target quantization scale of the sub-band.

An implementation process of parsing out the target quantization scales respectively corresponding to the m sub-bands from the bitstream in the non-differential decoding manner includes: parsing out the target quantization scales respectively corresponding to the m sub-bands from the bitstream in the non-differential entropy decoding manner.

In some embodiments, an encoding manner of the m sub-bands may be parsed out from the bitstream, to further determine whether the m sub-bands are encoded in the differential encoding manner or the non-differential encoding manner.

It should be noted that the entropy decoding may be Huffman decoding, or may be another decoding manner. This is not limited in this embodiment of this application.

When entropy decoding is Huffman decoding, a decoding codebook used in the non-differential entropy decoding manner is as follows:

{{0, 19, 3}, {1, 19, 3}, {2, 19, 3}, {3, 19, 3}, {4, 19, 3}, {5, 19, 3};
{6, 19, 3}, {7, 19, 3}, {8, 19, 3}, {9, 19, 3}, {10, 19, 3}, {11, 19, 3};
{12, 19, 3}, {13, 19, 3}, {14, 19, 3}, {15, 19, 3}, {16, 19, 3}, {17, 19, 3};
{18, 19, 3}, {19, 19, 3}, {20, 19, 3}, {21, 19, 3}, {22, 19, 3}, {23, 19, 3};
{24, 19, 3}, {25, 19, 3}, {26, 19, 3}, {27, 19, 3}, {28, 19, 3}, {29, 19, 3};
{30, 19, 3}, {31, 19, 3}, {32, 20, 3}, {33, 20, 3}, {34, 20, 3}, {35, 20, 3};
{36, 20, 3}, {37, 20, 3}, {38, 20, 3}, {39, 20, 3}, {40, 20, 3}, {41, 20, 3};
{42, 20, 3}, {43, 20, 3}, {44, 20, 3}, {45, 20, 3}, {46, 20, 3}, {47, 20, 3};
{48, 20, 3}, {49, 20, 3}, {50, 20, 3}, {51, 20, 3}, {52, 20, 3}, {53, 20, 3};
{54, 20, 3}, {55, 20, 3}, {56, 20, 3}, {57, 20, 3}, {58, 20, 3}, {59, 20, 3};
{60, 20, 3}, {61, 20, 3}, {62, 20, 3}, {63, 20, 3}, {64, 21, 3}, {65, 21, 3};
{66, 21, 3}, {67, 21, 3}, {68, 21, 3}, {69, 21, 3}, {70, 21, 3}, {71, 21, 3};
{72, 21, 3}, {73, 21, 3}, {74, 21, 3}, {75, 21, 3}, {76, 21, 3}, {77, 21, 3};
{78, 21, 3}, {79, 21, 3}, {80, 21, 3}, {81, 21, 3}, {82, 21, 3}, {83, 21, 3};
{84, 21, 3}, {85, 21, 3}, {86, 21, 3}, {87, 21, 3}, {88, 21, 3}, {89, 21, 3};
{90, 21, 3}, {91, 21, 3}, {92, 21, 3}, {93, 21, 3}, {94, 21, 3}, {95, 21, 3};
{96, 22, 3}, {97, 22, 3}, {98, 22, 3}, {99, 22, 3}, {100, 22, 3}, {101, 22, 3};
{102, 22, 3}, {103, 22, 3}, {104, 22, 3}, {105, 22, 3}, {106, 22, 3}, {107, 22, 3};
{108, 22, 3}, {109, 22, 3}, {110, 22, 3}, {111, 22, 3}, {112, 22, 3}, {113, 22, 3};
{114, 22, 3}, {115, 22, 3}, {116, 22, 3}, {117, 22, 3}, {118, 22, 3}, {119, 22, 3};
{120, 22, 3}, {121, 22, 3}, {122, 22, 3}, {123, 22, 3}, {124, 22, 3}, {125, 22, 3};
{126, 22, 3}, {127, 22, 3}, {128, 16, 4}, {129, 16, 4}, {130, 16, 4}, {131, 16, 4};
{132, 16, 4}, {133, 16, 4}, {134, 16, 4}, {135, 16, 4}, {136, 16, 4}, {137, 16, 4};
{138, 16, 4}, {139, 16, 4}, {140, 16, 4}, {141, 16, 4}, {142, 16, 4}, {143, 16, 4};
{144, 17, 4}, {145, 17, 4}, {146, 17, 4}, {147, 17, 4}, {148, 17, 4}, {149, 17, 4};
{150, 17, 4}, {151, 17, 4}, {152, 17, 4}, {153, 17, 4}, {154, 17, 4}, {155, 17, 4};
{156, 17, 4}, {157, 17, 4}, {158, 17, 4}, {159, 17, 4}, {160, 18, 4}, {161, 18, 4};
{162, 18, 4}, {163, 18, 4}, {164, 18, 4}, {165, 18, 4}, {166, 18, 4}, {167, 18, 4};
{168, 18, 4}, {169, 18, 4}, {170, 18, 4}, {171, 18, 4}, {172, 18, 4}, {173, 18, 4};
{174, 18, 4}, {175, 18, 4}, {176, 23, 4}, {177, 23, 4}, {178, 23, 4}, {179, 23, 4};
{180, 23, 4}, {181, 23, 4}, {182, 23, 4}, {183, 23, 4}, {184, 23, 4}, {185, 23, 4};
{186, 23, 4}, {187, 23, 4}, {188, 23, 4}, {189, 23, 4}, {190, 23, 4}, {191, 23, 4};
{192, 13, 5}, {193, 13, 5}, {194, 13, 5}, {195, 13, 5}, {196, 13, 5}, {197, 13, 5};
{198, 13, 5}, {199, 13, 5}, {200, 14, 5}, {201, 14, 5}, {202, 14, 5}, {203, 14, 5};
{204, 14, 5}, {205, 14, 5}, {206, 14, 5}, {207, 14, 5}, {208, 15, 5}, {209, 15, 5};
{210, 15, 5}, {211, 15, 5}, {212, 15, 5}, {213, 15, 5}, {214, 15, 5}, {215, 15, 5};
{216, 24, 5}, {217, 24, 5}, {218, 24, 5}, {219, 24, 5}, {220, 24, 5}, {221, 24, 5};
{222, 24, 5}, {223, 24, 5}, {224, 12, 6}, {225, 12, 6}, {226, 12, 6}, {227, 12, 6};
{228, 25, 6}, {229, 25, 6}, {230, 25, 6}, {231, 25, 6}, {232, 9, 7}, {233, 9, 7};
{234, 10, 7}, {235, 10, 7}, {236, 11, 7}, {237, 11, 7}, {238, 26, 7}, {239, 26, 7};
{240, 29, 7}, {241, 29, 7}, {242, 30, 7}, {243, 30, 7}, {244, 0, 8}, {245, 1, 8};
{246, 2, 8}, {247, 3, 8}, {248, 4, 8}, {249, 5, 8}, {250, 6, 8}, {251, 7, 8}; and
{252, 8, 8}, {253, 27, 8}, {254, 28, 8}, {255, 31, 8}}.

When entropy decoding is Huffman decoding, a decoding codebook used in the differential entropy decoding manner is as follows:

{{0, 6, 3}, {1, 6, 3}, {2, 6, 3}, {3, 6, 3}, {4, 6, 3}, {5, 6, 3};
{6, 6, 3}, {7, 6, 3}, {8, 6, 3}, {9, 6, 3}, {10, 6, 3}, {11, 6, 3};
{12, 6, 3}, {13, 6, 3}, {14, 6, 3}, {15, 6, 3}, {16, 10, 3}, {17, 10, 3};
{18, 10, 3}, {19, 10, 3}, {20, 10, 3}, {21, 10, 3}, {22, 10, 3}, {23, 10, 3};
{24, 10, 3}, {25, 10, 3}, {26, 10, 3}, {27, 10, 3}, {28, 10, 3}, {29, 10, 3};
{30, 10, 3}, {31, 10, 3}, {32, 12, 4}, {33, 12, 4}, {34, 12, 4}, {35, 12, 4};
{36, 12, 4}, {37, 12, 4}, {38, 12, 4}, {39, 12, 4}, {40, 4, 4}, {41, 4, 4};
{42, 4, 4}, {43, 4, 4}, {44, 4, 4}, {45, 4, 4}, {46, 4, 4}, {47, 4, 4};
{48, 7, 3}, {49, 7, 3}, {50, 7, 3}, {51, 7, 3}, {52, 7, 3}, {53, 7, 3};
{54, 7, 3}, {55, 7, 3}, {56, 7, 3}, {57, 7, 3}, {58, 7, 3}, {59, 7, 3};
{60, 7, 3}, {61, 7, 3}, {62, 7, 3}, {63, 7, 3}, {64, 9, 3}, {65, 9, 3};
{66, 9, 3}, {67, 9, 3}, {68, 9, 3}, {69, 9, 3}, {70, 9, 3}, {71, 9, 3};
{72, 9, 3}, {73, 9, 3}, {74, 9, 3}, {75, 9, 3}, {76, 9, 3}, {77, 9, 3};
{78, 9, 3}, {79, 9, 3}, {80, 8, 3}, {81, 8, 3}, {82, 8, 3}, {83, 8, 3};
{84, 8, 3}, {85, 8, 3}, {86, 8, 3}, {87, 8, 3}, {88, 8, 3}, {89, 8, 3};
{90, 8, 3}, {91, 8, 3}, {92, 8, 3}, {93, 8, 3}, {94, 8, 3}, {95, 8, 3};
{96, 13, 5}, {97, 13, 5}, {98, 13, 5}, {99, 13, 5}, {100, 1, 6}, {101, 1, 6};
{102, 14, 6}, {103, 14, 6}, {104, 5, 4}, {105, 5, 4}, {106, 5, 4}, {107, 5, 4};
{108, 5, 4}, {109, 5, 4}, {110, 5, 4}, {111, 5, 4}, {112, 11, 4}, {113, 11, 4};
{114, 11, 4}, {115, 11, 4}, {116, 11, 4}, {117, 11, 4}, {118, 11, 4}, {119, 11, 4};
{120, 3, 5}, {121, 3, 5}, {122, 3, 5}, {123, 3, 5}, {124, 0, 7}, {125, 15, 7}; and
{126, 2, 6}, {127, 2, 6}}.

In a second case, when the current bandwidth cut-off coefficient indicates the full band, the target quantization scales respectively corresponding to the m sub-bands do not need to be parsed out from the bitstream.

When the current bandwidth cut-off coefficient indicates the full band, it indicates that all the target quantization scales respectively corresponding to the m sub-bands are parsed out from the bitstream. In this case, the target quantization scales respectively corresponding to the m sub-bands do not need to be parsed out from the bitstream.

Step 804: Allocate quantization bits to the m sub-bands based on current remaining quantization scales respectively corresponding to the m sub-bands, where the current remaining quantization scale is an unallocated quantization scale remaining after a quantization bit is allocated to a corresponding sub-band last time.

When the current remaining quantization scales respectively corresponding to the m sub-bands are different, the quantization bits are allocated to the m sub-bands in different manners, which are separately described below.

In a first case, when the current remaining quantization scales respectively corresponding to the m sub-bands are all 0s, a quantization and decoding cycle of the spectrum of the audio signal ends.

When the current remaining quantization scales respectively corresponding to the m sub-bands are all 0s, it indicates that the plurality of sub-bands included in the spectrum of the audio signal are all parsed out from the bitstream. In this case, a quantization and decoding cycle of the plurality of sub-bands may be ended, and a quantization and decoding cycle of a sub-band included in a next spectrum is performed.

In a second case, the quantization bits are allocated to the m sub-bands based on the current remaining quantization scales respectively corresponding to the m sub-bands when the current remaining quantization scales respectively corresponding to the m sub-bands are not all 0s and are all less than a quantization step.

When the current remaining quantization scales respectively corresponding to the m sub-bands are not all 0s, it indicates that the m sub-bands further include a sub-band whose decoding is not completed in the m sub-bands. Therefore, the quantization bits further need to be allocated to the m sub-bands. When the current remaining quantization scales respectively corresponding to the m sub-bands are all less than a quantization step, it indicates that the quantization bits respectively corresponding to the m sub-bands are all within a range of the quantization step. Therefore, the current remaining quantization scales respectively corresponding to the m sub-bands may be directly used as the quantization bits allocated to the m sub-bands.

It should be noted that, for different quantization and decoding cycles, quantization steps corresponding to all the quantization and decoding cycles may be the same or may be different. This is not limited in this embodiment of this application.

In a third case, when a current remaining quantization scale of at least one of the m sub-bands is greater than a quantization step, psychoacoustic masking is performed on the current remaining quantization scales respectively corresponding to the m sub-bands, to obtain masked remaining quantization scales respectively corresponding to the m sub-bands; the masked remaining quantization scales respectively corresponding to the m sub-bands are scaled based on the quantization step, to obtain scaled remaining quantization scales respectively corresponding to the m sub-bands; and the quantization bits are allocated to the m sub-bands based on the scaled remaining quantization scales respectively corresponding to the m sub-bands and the target quantization scales respectively corresponding to the m sub-bands.

When the current remaining quantization scale of the at least one of the m sub-bands is greater than the quantization step, it indicates that quantization bits of some of the m sub-bands are not within a range of the quantization step. Therefore, the remaining quantization scales respectively corresponding to the m sub-bands need to be processed in a psychoacoustic masking manner, to distinguish importance degrees of the m sub-bands.

In some embodiments, a largest value in the masked quantization scales respectively corresponding to the m sub-bands may be determined, and the masked remaining quantization scales respectively corresponding to the m sub-bands are scaled based on the masked quantization scales respectively corresponding to the m sub-bands, the largest value in the masked quantization scales respectively corresponding to the m sub-bands, and the quantization step, to obtain the scaled remaining quantization scales respectively corresponding to the m sub-bands. For a detailed implementation process, refer to related content in step 404. Details are not described herein again.

After the scaled remaining quantization scales respectively corresponding to the m sub-bands are determined, for any one of the m sub-bands, a smaller value in a scaled remaining quantization scale and a target quantization scale that are of the sub-band is determined as a quantization bit allocated to the sub-band.

After the quantization bits are allocated to the m sub-bands in the foregoing manner, the remaining quantization scales respectively corresponding to the m sub-bands may be updated. That is, for any one of the m sub-bands, a quantization bit allocated to the sub-band this time is subtracted from a current remaining quantization scale of the sub-band, to obtain an updated remaining quantization scale of the sub-band.

Step 805: Parse out frequency band information in the m sub-bands from the bitstream based on the quantization bits currently allocated to the m sub-bands.

Because the plurality of times of cyclic quantization and decoding are performed on the sub-band included in the spectrum of the audio signal, the quantization bits allocated to the m sub-bands based on the current remaining quantization scales respectively corresponding to the m sub-bands may also be referred to as the quantization bits currently allocated to the m sub-bands, or quantization bits allocated to the m sub-bands in a current cycle.

Because hierarchical quantization and decoding are performed on the plurality of sub-bands included in the spectrum of the audio signal, for a same sub-band, hierarchical quantization and decoding may also be performed on frequency band information in the sub-band. In other words, different frequency band information in a same sub-band may be located at different quantization layers. When channels of the sub-band are located at different quantization layers, the frequency band information in the sub-band is parsed out from the bitstream in different manners. The following provides descriptions by using any one of the m sub-bands as an example.

In a first case, when a current quantization layer quantity of a target sub-band is less than or equal to a maximum quantization layer quantity, if a quantization bit currently allocated to the target sub-band is 1, frequency band information in the target sub-band is parsed out from the bitstream in the entropy decoding manner based on the quantization bit currently allocated to the target sub-band. The target sub-band is any one of the m sub-bands.

The current quantization layer quantity of the target sub-band is a ranking of a quantization and decoding cycle in which the frequency band information in the target sub-band is currently decoded. The maximum quantization layer quantity is preset. In different cases, values of the maximum quantization layer quantity may be different.

An implementation process of parsing out the frequency band information in the target sub-band from the bitstream in the entropy decoding manner based on the quantization bit currently allocated to the target sub-band includes: parsing out every plurality of bits in the frequency band information in the target sub-band from the bitstream as a group in the entropy decoding manner based on the quantization bit currently allocated to the target sub-band.

In an example, when the current quantization layer of the target sub-band is a first layer and a bandwidth of the target sub-band is greater than 1, every n bits in the frequency band information in the target sub-band are parsed out from the bitstream as a group in the entropy decoding manner based on the quantization bit currently allocated to the target sub-band, where n is an integer greater than 1; when the current quantization layer of the target sub-band is a second layer, every k bits in the frequency band information in the target sub-band are parsed out from the bitstream as a group in the entropy decoding manner based on the quantization bit currently allocated to the target sub-band, where k is an integer greater than 1; and when the current quantization layer of the target sub-band is greater than or equal to a third layer, every h bits in the frequency band information in the target sub-band are parsed out from the bitstream as a group in the entropy decoding manner based on the quantization bit currently allocated to the target sub-band, where h is an integer greater than 1.

In some embodiments, when the current quantization layer of the target sub-band is the first layer and the bandwidth of the target sub-band is 1, it indicates that the value of the frequency band information in the target sub-band is 1, and decoding may not need to be performed.

Values of n, k, and h may be the same, or may be different. For example, n is 4, k is 3, and h is 2. The values of n, k, and h may be different when requirements are different. In addition, when a sub-band includes frequency band information that is not grouped, for the frequency band information that is not grouped, the frequency band information may be parsed out from the bitstream in a binary decoding manner.

The entropy decoding may be Hoffman decoding. For example, when n is 4, every n bits in the frequency band information in the target sub-band are parsed out from the bitstream as a group in the Huffman decoding manner, and a used decoding codebook is shown as follows:

| | |
|---|---|
| | {{0, 1, 3}, {1, 1, 3}, {2, 1, 3}, {3, 1, 3}, {4, 1, 3}, {5, 1, 3}, {6, 1, 3}; |
| | {7, 1, 3}, {8, 1, 3}, {9, 1, 3}, {10, 1, 3}, {11, 1, 3}, {12, 1, 3}, {13, 1, 3}; |
| | {14, 1, 3}, {15, 1, 3}, {16, 1, 3}, {17, 1, 3}, {18, 1, 3}, {19, 1, 3}, {20, 1, 3}; |
| | {21, 1, 3}, {22, 1, 3}, {23, 1, 3}, {24, 1, 3}, {25, 1, 3}, {26, 1, 3}, {27, 1, 3}; |
| | {28, 1, 3}, {29, 1, 3}, {30, 1, 3}, {31, 1, 3}, {32, 8, 3}, {33, 8, 3}, {34, 8, 3}; |
| | {35, 8, 3}, {36, 8, 3}, {37, 8, 3}, {38, 8, 3}, {39, 8, 3}, {40, 8, 3}, {41, 8, 3}; |
| | {42, 8, 3}, {43, 8, 3}, {44, 8, 3}, {45, 8, 3}, {46, 8, 3}, {47, 8, 3}, {48, 8, 3}; |
| | {49, 8, 3}, {50, 8, 3}, {51, 8, 3}, {52, 8, 3}, {53, 8, 3}, {54, 8, 3}, {55, 8, 3}; |
| | {56, 8, 3}, {57, 8, 3}, {58, 8, 3}, {59, 8, 3}, {60, 8, 3}, {61, 8, 3}, {62, 8, 3}; |
| | {63, 8, 3}, {64, 13, 7}, {65, 13, 7}, {66, 7, 7}, {67, 7, 7}, {68, 14, 7}, {69, 14, 7}; |
| | {70, 15, 8}, {71, 11, 8}, {72, 9, 6}, {73, 9, 6}, {74, 9, 6}, {75, 9, 6}, {76, 5, 6}; |
| | {77, 5, 6}, {78, 5, 6}, {79, 5, 6}, {80, 10, 6}, {81, 10, 6}, {82, 10, 6}, {83, 10, 6}; |
| | {84, 6, 6}, {85, 6, 6}, {86, 6, 6}, {87, 6, 6}, {88, 3, 6}, {89, 3, 6}, {90, 3, 6}; |
| | {91, 3, 6}, {92, 12, 6}, {93, 12, 6}, {94, 12, 6}, {95, 12, 6}, {96, 2, 4}, {97, 2, 4}; |
| | {98, 2, 4}, {99, 2, 4}, {100, 2, 4}, {101, 2, 4}, {102, 2, 4}, {103, 2, 4}, {104, 2, 4}; |
| | {105, 2, 4}, {106, 2, 4}, {107, 2, 4}, {108, 2, 4}, {109, 2, 4}, {110, 2, 4}, {111, 2, 4}; |
| | {112, 4, 4}, {113, 4, 4}, {114, 4, 4}, {115, 4, 4}, {116, 4, 4}, {117, 4, 4}, {118, 4, 4}; |
| | {119, 4, 4}, {120, 4, 4}, {121, 4, 4}, {122, 4, 4}, {123, 4, 4}, {124, 4, 4}, {125, 4, 4}; |
| | {126, 4, 4}, {127, 4, 4}, {128, 0, 1}, {129, 0, 1}, {130, 0, 1}, {131, 0, 1}, {132, 0, 1}; |
| | {133, 0, 1}, {134, 0, 1}, {135, 0, 1}, {136, 0, 1}, {137, 0, 1}, {138, 0, 1}, {139, 0, 1}; |
| | {140, 0, 1}, {141, 0, 1}, {142, 0, 1}, {143, 0, 1}, {144, 0, 1}, {145, 0, 1}, {146, 0, 1}; |
| | {147, 0, 1}, {148, 0, 1}, {149, 0, 1}, {150, 0, 1}, {151, 0, 1}, {152, 0, 1}, {153, 0, 1}; |
| | {154, 0, 1}, {155, 0, 1}, {156, 0, 1}, {157, 0, 1}, {158, 0, 1}, {159, 0, 1}, {160, 0, 1}; |
| | {161, 0, 1}, {162, 0, 1}, {163, 0, 1}, {164, 0, 1}, {165, 0, 1}, {166, 0, 1}, {167, 0, 1}; |
| | {168, 0, 1}, {169, 0, 1}, {170, 0, 1}, {171, 0, 1}, {172, 0, 1}, {173, 0, 1}, {174, 0, 1}; |
| | {175, 0, 1}, {176, 0, 1}, {177, 0, 1}, {178, 0, 1}, {179, 0, 1}, {180, 0, 1}, {181, 0, 1}; |
| | {182, 0, 1}, {183, 0, 1}, {184, 0, 1}, {185, 0, 1}, {186, 0, 1}, {187, 0, 1}, {188, 0, 1}; |
| | {189, 0, 1}, {190, 0, 1}, {191, 0, 1}, {192, 0, 1}, {193, 0, 1}, {194, 0, 1}, {195, 0, 1}; |
| | {196, 0, 1}, {197, 0, 1}, {198, 0, 1}, {199, 0, 1}, {200, 0, 1}, {201, 0, 1}, {202, 0, 1}; |
| | {203, 0, 1}, {204, 0, 1}, {205, 0, 1}, {206, 0, 1}, {207, 0, 1}, {208, 0, 1}, {209, 0, 1}; |
| | {210, 0, 1}, {211, 0, 1}, {212, 0, 1}, {213, 0, 1}, {214, 0, 1}, {215, 0, 1}, {216, 0, 1}; |
| | {217, 0, 1}, {218, 0, 1}, {219, 0, 1}, {220, 0, 1}, {221, 0, 1}, {222, 0, 1}, {223, 0, 1}; |
| | {224, 0, 1}, {225, 0, 1}, {226, 0, 1}, {227, 0, 1}, {228, 0, 1}, {229, 0, 1}, {230, 0, 1}; |
| | {231, 0, 1}, {232, 0, 1}, {233, 0, 1}, {234, 0, 1}, {235, 0, 1}, {236, 0, 1}, {237, 0, 1}; |
| | {238, 0, 1}, {239, 0, 1}, {240, 0, 1}, {241, 0, 1}, {242, 0, 1}, {243, 0, 1}, {244, 0, 1}; |
| | {245, 0, 1}, {246, 0, 1}, {247, 0, 1}, {248, 0, 1}, {249, 0, 1}, {250, 0, 1}, {251, 0, 1}; |
| and | |
| | {252, 0, 1}, {253, 0, 1}, {254, 0, 1}, {255, 0, 1}, {256, 0, 1}}. |

When k is 3, every k bits in the frequency band information in the target sub-band are parsed out from the bitstream as a group in the Huffman decoding manner, and a used decoding codebook is shown as follows:

| | |
|---|---|
| | {{0, 0, 1}, {1, 0, 1}, {2, 0, 1}, {3, 0, 1}, {4, 0, 1}, {5, 0, 1}, {6, 0, 1}, {7, 0, 1}; |
| | {8, 0, 1}, {9, 0, 1}, {10, 0, 1}, {11, 0, 1}, {12, 0, 1}, {13, 0, 1}, {14, 0, 1}, {15, 0, 1}; |
| | {16, 1, 3}, {17, 1, 3}, {18, 1, 3}, {19, 1, 3}, {20, 2, 3}, {21, 2, 3}, {22, 2, 3}, {23, 2, |
| 3}; and | |
| | {24, 4, 3}, {25, 4, 3}, {26, 4, 3}, {27, 4, 3}, {28, 7, 5}, {29, 5, 5}, {30, 3, 5}, {31, 6, |
| 5}}. | |

When h is 2, every h bits in the frequency band information in the target sub-band are parsed out from the bitstream as a group in the Huffman decoding manner, and a used decoding codebook is shown as follows:

{{0, 0, 1}, {1, 0, 1}, {2, 0, 1}, {3, 0, 1}, {4, 2, 2}, {5, 2, 2}, {6, 3, 3}, {7, 1, 3}}.

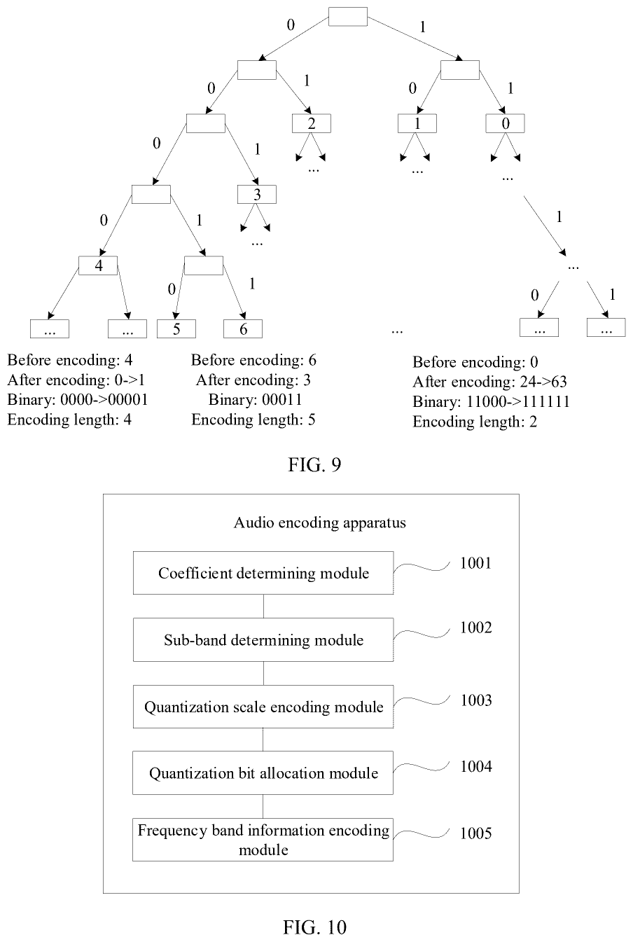

Unique prefix encoding is used in Huffman encoding, and a codebook on the decoder side is extended based on a maximum encoding length, to ensure that values mapped during encoding and decoding are unique. To be specific, for the decoder side, as shown in FIG. 9, a decoding codebook may be extended by using an encoding codebook. To be specific, a Huffman tree is supplemented to be a complete binary tree, and a quantity of bits read through Huffman decoding on the decoder side is unified to be a maximum Huffman tree depth, to omit encoding of a code value length, and improve compression efficiency.

In a second case, when a current quantization layer quantity of a target sub-band is less than or equal to a maximum quantization layer quantity, if a quantization bit currently allocated to the target sub-band is greater than 1, frequency band information in the target sub-band is parsed out from the bitstream in the binary decoding manner based on the quantization bit currently allocated to the target sub-band. The target sub-band is any one of the m sub-bands.

In a third case, when a current quantization layer quantity of a target sub-band is greater than a maximum quantization layer quantity, frequency band information in the target sub-band is parsed out from the bitstream in a binary decoding manner based on a quantization bit currently allocated to the target sub-band. The target sub-band is any one of the m sub-bands.

In some embodiments, after the parsing out frequency band information in the m sub-bands from the bitstream based on the quantization bits currently allocated to the m sub-bands, the method further includes: when parsing of the target sub-band ends, if a quantity of parsed-out bits of target frequency band information in the target sub-band is less than a target quantization scale of the target sub-band, performing low-order bit padding on the target frequency band information, where the target sub-band is any one of the m sub-bands, and the target frequency band information is any piece of frequency band information in the target sub-band.

If the quantity of parsed-out bits of the target frequency band information in the target sub-band is less than the target quantization scale of the target sub-band, it indicates that quantization and encoding of the target frequency band information is not lossless. In this case, low-order bit padding may be performed on the target frequency band information. In a process of low-order bit padding, 0 and 1 may be randomly padded, and a padding probability of 0 is the same as that of 1.

Based on the foregoing descriptions, the audio signal may be an audio signal of a single channel, or may be audio signals of dual channels, or may be audio signals of a plurality of channels. In addition, the encoder side may separately quantize and encode audio signals of all channels, or mix audio signals of all channels together for quantization and encoding. In addition, the decoder side supports three decoding modes: left-channel decoding, right-channel decoding, and stereo decoding.

In some embodiments, the audio signal has side information, the side information includes an encoding flag bit, and the audio signal is an audio signal of a single channel when the encoding flag bit is a first value. That is, the encoder side separately quantizes and encodes the audio signals of all the channels. The audio signal is audio signals of a plurality of channels when the encoding flag bit is a second value. That is, the encoder side mixes the audio signals of all the channels together for quantization and encoding.

When the encoder side separately quantizes and encodes the audio signals of all the channels, the audio signals of all the channels may be obtained by directly parsing the bitstream. When the encoder side mixes the audio signals of all the channels for quantization and encoding, if a stereo bitstream is not interleaved, after a header and partial common side information are parsed out, remaining bits are evenly allocated based on all the channels, to parse out the audio signals of all the channels.

In this embodiment of this application, hierarchical quantization and encoding are performed on the sub-band included in the spectrum, to support both a lossy encoding feature and a lossless encoding feature. Therefore, a decoder side can also support both a lossy decoding feature and a lossless decoding feature, to greatly reduce algorithm complexity, and avoid low-efficiency switching between a lossy framework and a lossless framework. In addition, in a process of hierarchical quantization decoding, quantization is performed while decoding is performed. Regardless of how much information is sent by the encoder side, the decoder side may parse out the information from the bitstream, to greatly improve a channel adaptive capability of the bitstream in a communication process. In addition, when the decoder side determines, through parsing, that specific frequency band information is not lossless, a value of the frequency band information may be further padded in a low-order bit padding manner, to reduce an overall quantization error, and effectively compensate for a case in which an amplitude of the audio signal is reduced due to a bit loss in lossy encoding.

FIG. 10 is a diagram of a structure of an audio encoding apparatus according to an embodiment of this application. The audio encoding apparatus may be implemented as a part or all of an audio encoding device by using software, hardware, or a combination thereof. The audio encoding device may be the foregoing encoder side. As shown in FIG. 10, the apparatus includes a coefficient determining module 1001, a sub-band determining module 1002, a quantization scale encoding module 1003, a quantization bit allocation module 1004, and a frequency band information encoding module 1005.

The coefficient determining module 1001 is configured to determine a current bandwidth cut-off coefficient based on a quantity of currently used bits, a quantity of channels, and a quantity of sampling points that are of an audio signal. The quantity of currently used bits is a quantity of bits consumed by encoding a spectrum of a current audio frame of the audio signal before current time.

The sub-band determining module 1002 is configured to determine, based on the current bandwidth cut-off coefficient, m current to-be-encoded sub-bands from a plurality of sub-bands included in the spectrum. Herein, m is greater than or equal to 1 and less than or equal to a total quantity of the plurality of sub-bands.

The quantization scale encoding module 1003 is configured to encode target quantization scales respectively corresponding to the m sub-bands into a bitstream based on the current bandwidth cut-off coefficient. The target quantization scale is a quantity of bits required for encoding frequency band information with a largest amplitude in a corresponding sub-band.

The quantization bit allocation module 1004 is configured to allocate quantization bits to the m sub-bands based on current remaining quantization scales respectively corresponding to the m sub-bands. The current remaining quantization scale is an unallocated quantization scale remaining after a quantization bit is allocated to a corresponding sub-band last time.

The frequency band information encoding module 1005 is configured to encode frequency band information in the m sub-bands into the bitstream based on the quantization bits currently allocated to the m sub-bands.

Optionally, the quantization scale encoding module 1003 is specifically configured to:
when the current bandwidth cut-off coefficient indicates a non-full band, determine a difference between target quantization scales of every two adjacent sub-bands in the m sub-bands, to obtain m-1 quantization scale differences;
determine a smallest value and a largest value in the m-1 quantization scale differences; and
encode the target quantization scales respectively corresponding to the m sub-bands into the bitstream in a differential encoding manner if the smallest value is greater than a first threshold and the largest value is less than a second threshold.

Optionally, the quantization bit allocation module 1004 is specifically configured to:
allocate the quantization bits to the m sub-bands based on the current remaining quantization scales respectively corresponding to the m sub-bands when the current remaining quantization scales respectively corresponding to the m sub-bands are not all 0s and are all less than a quantization step.

Optionally, the quantization bit allocation module 1004 is specifically configured to:
when a current remaining quantization scale of at least one of the m sub-bands is greater than a quantization step, perform psychoacoustic masking on the current remaining quantization scales respectively corresponding to the m sub-bands, to obtain masked remaining quantization scales respectively corresponding to the m sub-bands;
scale the masked remaining quantization scales respectively corresponding to the m sub-bands based on the quantization step, to obtain scaled remaining quantization scales respectively corresponding to the m sub-bands; and
allocate the quantization bits to the m sub-bands based on the scaled remaining quantization scales respectively corresponding to the m sub-bands and the target quantization scales respectively corresponding to the m sub-bands.

Optionally, the frequency band information encoding module 1005 is specifically configured to:
when a current quantization layer quantity of a target sub-band is less than or equal to a maximum quantization layer quantity, if a quantization bit currently allocated to the target sub-band is 1, encode frequency band information in the target sub-band into the bitstream in an entropy encoding manner based on the quantization bit currently allocated to the target sub-band, where the target sub-band is any one of the m sub-bands.

Optionally, the frequency band information encoding module 1005 is specifically configured to:
when a current quantization layer quantity of a target sub-band is less than or equal to a maximum quantization layer quantity, if a quantization bit currently allocated to the target sub-band is greater than 1, encode frequency band information in the target sub-band into the bitstream in a binary encoding manner based on the quantization bit currently allocated to the target sub-band, where the target sub-band is any one of the m sub-bands.

Optionally, the frequency band information encoding module 1005 is specifically configured to:
when a current quantization layer quantity of a target sub-band is greater than a maximum quantization layer quantity, encode frequency band information in the target sub-band into the bitstream in a binary encoding manner based on a quantization bit currently allocated to the target sub-band, where the target sub-band is any one of the m sub-bands.

Optionally, the audio signal has side information, the side information includes an encoding flag bit, and the audio signal is an audio signal of a single channel when the encoding flag bit is a first value, or the audio signal is an audio signal of a plurality of channels when the encoding flag bit is a second value.

In this embodiment of this application, hierarchical quantization and encoding are performed on the sub-band included in the spectrum. An insufficient bit rate corresponds to a state of lossy encoding, and an enough bit rate corresponds to a state of lossless encoding. In other words, the quantization and encoding manner provided in this embodiment of this application can support both a lossy encoding feature and a lossless encoding feature, to greatly reduce algorithm complexity and avoid low-efficiency switching between a lossy framework and a lossless framework. In addition, in a process of hierarchical quantization and encoding, quantization is performed while encoding is performed, to randomly truncate an encoded bitstream when a bit rate changes. In other words, an audio frame encoded in this solution has a single-frame multi-bit rate feature. Compared with a manner in which quantization is performed before encoding, this solution can avoid a case in which truncation cannot be performed and encoding needs to be performed again when the bit rate changes, to greatly improve channel adaptive capability in a communication process.

It should be noted that, when the audio encoding apparatus provided in the foregoing embodiment performs video encoding, division into the foregoing functional modules is merely used as an example for description. During actual application, the foregoing functions may be allocated to different functional modules for implementation according to a requirement. In other words, an internal structure of the apparatus is divided into different functional modules to implement all or some of the functions described above. In addition, the audio encoding apparatus provided in the foregoing embodiment and the audio encoding method embodiment belong to a same concept. For a specific implementation process of the audio encoding apparatus and the audio encoding method, refer to the method embodiment. Details are not described herein again.

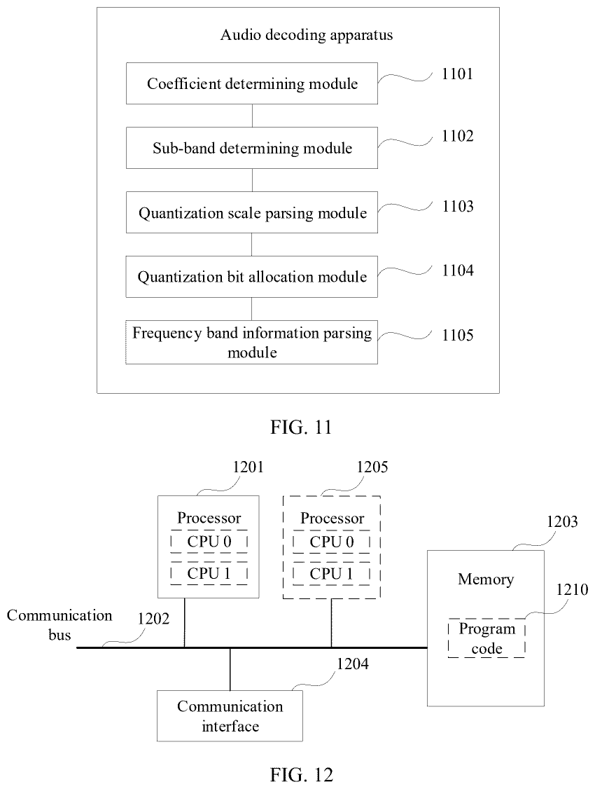

FIG. 11 is a diagram of a structure of an audio decoding apparatus according to an embodiment of this application. The audio decoding apparatus may be implemented as a part or all of an audio decoding device by using software, hardware, or a combination thereof. The audio decoding device may be the foregoing decoder side. As shown in FIG. 11, the apparatus includes a coefficient determining module 1101, a sub-band determining module 1102, a quantization scale parsing module 1103, a quantization bit allocation module 1104, and a frequency band information parsing module 1105.

The coefficient determining module 1101 is configured to determine a current bandwidth cut-off coefficient based on a quantity of currently used bits, a quantity of channels, and a quantity of sampling points that are of an audio signal. The quantity of currently used bits is a quantity of bits consumed by decoding a spectrum of a current audio frame of the audio signal before current time.

The sub-band determining module 1102 is configured to determine, based on the current bandwidth cut-off coefficient, m current to-be-decoded sub-bands from a plurality of sub-bands included in the spectrum. Herein, m is greater than or equal to 1 and less than or equal to a total quantity of the plurality of sub-bands.

The quantization scale parsing module 1103 is configured to parse out target quantization scales respectively corresponding to the m sub-bands from a bitstream based on the current bandwidth cut-off coefficient. The target quantization scale is a quantity of bits required for encoding frequency band information with a largest amplitude in a corresponding sub-band.

The quantization bit allocation module 1104 is configured to allocate quantization bits to the m sub-bands based on current remaining quantization scales respectively corresponding to the m sub-bands. The current remaining quantization scale is an unallocated quantization scale remaining after a quantization bit is allocated to a corresponding sub-band last time.

The frequency band information parsing module 1105 is configured to parse out frequency band information in the m sub-bands from the bitstream based on the quantization bits currently allocated to the m sub-bands.

Optionally, the quantization scale parsing module 1103 is specifically configured to:
when the current bandwidth cut-off coefficient indicates a non-full band, parse out the target quantization scales respectively corresponding to the m sub-bands from the bitstream.

Optionally, the quantization bit allocation module 1104 is specifically configured to:
allocate the quantization bits to the m sub-bands based on the current remaining quantization scales respectively corresponding to the m sub-bands when the current remaining quantization scales respectively corresponding to the m sub-bands are all less than a quantization step.

Optionally, the quantization bit allocation module 1104 is specifically configured to:
when a current remaining quantization scale of at least one of the m sub-bands is greater than a quantization step, perform psychoacoustic masking on the current remaining quantization scales respectively corresponding to the m sub-bands, to obtain masked remaining quantization scales respectively corresponding to the m sub-bands;
scale the masked remaining quantization scales respectively corresponding to the m sub-bands based on the quantization step, to obtain scaled remaining quantization scales respectively corresponding to the m sub-bands; and
allocate the quantization bits to the m sub-bands based on the scaled remaining quantization scales respectively corresponding to the m sub-bands and the target quantization scales respectively corresponding to the m sub-bands.

Optionally, the frequency band information parsing module 1105 is specifically configured to:
when a current quantization layer quantity of a target sub-band is less than or equal to a maximum quantization layer quantity, if a quantization bit currently allocated to the target sub-band is 1, parse out frequency band information in the target sub-band from the bitstream in an entropy decoding manner based on the quantization bit currently allocated to the target sub-band, where the target sub-band is any one of the m sub-bands.

Optionally, the frequency band information parsing module 1105 is specifically configured to:
when a current quantization layer quantity of a target sub-band is less than or equal to a maximum quantization layer quantity, if a quantization bit currently allocated to the target sub-band is greater than 1, parse out frequency band information in the target sub-band from the bitstream in a binary decoding manner based on the quantization bit currently allocated to the target sub-band, where the target sub-band is any one of the m sub-bands.

Optionally, the frequency band information parsing module 1105 is specifically configured to:
when a current quantization layer quantity of a target sub-band is greater than a maximum quantization layer quantity, parse out frequency band information in the target sub-band from the bitstream in a binary decoding manner based on a quantization bit currently allocated to the target sub-band, where the target sub-band is any one of the m sub-bands.

Optionally, the apparatus further includes:
a bit padding module, configured to: when parsing of the target sub-band ends, if a quantity of parsed-out bits of target frequency band information in the target sub-band is less than a target quantization scale of the target sub-band, perform low-order bit padding on the target frequency band information, where the target sub-band is any one of the m sub-bands, and the target frequency band information is any piece of frequency band information in the target sub-band.

In this embodiment of this application, hierarchical quantization and encoding are performed on the sub-band included in the spectrum, to support both a lossy encoding feature and a lossless encoding feature. Therefore, a decoder side can also support both a lossy decoding feature and a lossless decoding feature, to greatly reduce algorithm complexity, and avoid low-efficiency switching between a lossy framework and a lossless framework. In addition, in a process of hierarchical quantization decoding, quantization is performed while decoding is performed. Regardless of how much information is sent by the encoder side, the decoder side may parse out the information from the bitstream, to greatly improve a channel adaptive capability of the bitstream in a communication process. In addition, when the decoder side determines, through parsing, that specific frequency band information is not lossless, a value of the frequency band information may be further padded in a low-order bit padding manner, to reduce an overall quantization error, and effectively compensate for a case in which an amplitude of the audio signal is reduced due to a bit loss in lossy encoding.

It should be noted that, when the audio decoding apparatus provided in the foregoing embodiment performs video decoding, division into the foregoing functional modules is merely used as an example for description. During actual application, the foregoing functions may be allocated to different functional modules for implementation according to a requirement. In other words, an internal structure of the apparatus is divided into different functional modules to implement all or some of the functions described above. In addition, the audio decoding apparatus provided in the foregoing embodiment and the audio decoding method embodiment belong to a same concept. For a specific implementation process of the audio decoding apparatus and the audio decoding method, refer to the method embodiment. Details are not described herein again.

FIG. 12 is a diagram of a structure of an electronic device according to an embodiment of this application. Optionally, the electronic device may be the foregoing audio encoding device or audio decoding device. The electronic device includes one or more processors 1201, a communication bus 1202, a memory 1203, and one or more communication interfaces 1204.

The processor 1201 is a general-purpose central processing unit (CPU), a network processor (NP), a microprocessor, or one or more integrated circuits configured to implement the solutions of this application, for example, an application-specific integrated circuit (ASIC), a programmable logic device (PLD), or a combination thereof. Optionally, the PLD is a complex programmable logic device (CPLD), a field-programmable gate array (FPGA), generic array logic (GAL), or any combination thereof.

The communication bus 1204 is configured to transfer information between the foregoing components. Optionally, the communication bus 1202 may be classified into an address bus, a data bus, a control bus, or the like. For ease of representation, only one bold line is used for indication in the figure, but it does not indicate that there is only one bus or only one type of bus.

Optionally, the memory 1203 is a read-only memory (ROM), a random access memory (RAM), an electrically erasable programmable read-only memory (EEPROM), an optical disc (including a compact disc read-only memory (CD-ROM), a compact disc, a laser disc, a digital versatile disc, a Blu-ray disc, and the like), a magnetic disk storage medium, another magnetic storage device, or any other medium that can be used to carry or store expected program code in a form of instructions or a data structure and that can be accessed by a computer, but is not limited thereto. The memory 1203 exists independently, and is connected to the processor 1201 through the communication bus 1202, or the memory 1203 is integrated with the processor 1201.

The communication interface 1204 is configured to communicate with another device or a communication network by using any apparatus like a transceiver. The communication interface 1204 includes a wired communication interface, and optionally, further includes a wireless communication interface. The wired communication interface is, for example, an Ethernet interface. Optionally, the Ethernet interface is an optical interface, an electrical interface, or a combination thereof. The wireless communication interface is a wireless local area network (WLAN) interface, a cellular network communication interface, a combination thereof, or the like.

Optionally, in some embodiments, the electronic device includes a plurality of processors, for example, the processor 1201 and a processor 1205 shown in FIG. 12. Each of these processors is a single-core processor or a multi-core processor. Optionally, the processor herein is one or more devices, circuits, and/or processing cores for processing data (for example, computer program instructions).

During specific implementation, in an embodiment, the electronic device further includes an output device 1206 and an input device 1207. The output device 1206 communicates with the processor 1201, and can display information in a plurality of manners. For example, the output device 1206 is a liquid crystal display (LCD), a light emitting diode (LED) display device, a cathode ray tube (CRT) display device, a projector, or the like. The input device 1207 communicates with the processor 1201, and can receive an input of a user in a plurality of manners. For example, the input device 1207 is a mouse, a keyboard, a touchscreen device, or a sensor device.

In some embodiments, the memory 1203 is configured to store program code 1210 for performing the solutions of this application, and the processor 1201 may execute the program code 1210 stored in the memory 1203. The program code includes one or more software modules, and the electronic device can implement, by using the processor 1201 and the program code 1210 in the memory 1203, the audio signal processing method provided in the following embodiment in FIG. 4 or FIG. 8.

An embodiment of this application further provides a computer-readable storage medium. The storage medium stores instructions, and when the instructions run on a computer, the computer is enabled to perform the audio encoding method or the audio decoding method.

An embodiment of this application further provides a computer program product including instructions. When the instructions run on a computer, the computer is enabled to perform the audio encoding method or the audio decoding method. In other words, a computer program is provided. When the computer program runs on a computer, the computer is enabled to perform the audio encoding method or audio decoding method.

All or some of the foregoing embodiments may be implemented by software, hardware, firmware, or any combination thereof. When software is used to implement the embodiments, all or a part of the embodiments may be implemented in a form of a computer program product. The computer program product includes one or more computer instructions. When the computer instructions are loaded and executed on the computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a digital versatile disc (DVD)), a semiconductor medium (for example, a solid state disk (SSD)), or the like. It should be noted that the computer-readable storage medium mentioned in embodiments of this application may be a non-volatile storage medium, that is, may be a non-transitory storage medium.

It should be understood that “a plurality of” in this specification means two or more. In descriptions of embodiments of this application, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and B exist, and only B exists. In addition, to clearly describe technical solutions in embodiments of this application, terms such as “first” and “second” are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference.

It should be noted that information (including but not limited to user equipment information, personal information of a user, and the like), data (including but not limited to data used for analysis, stored data, displayed data, and the like), and signals in embodiments of this application are used under authorization by the user or full authorization by all parties, and capturing, use, and processing of related data need to conform to related laws, regulations, and standards of related countries and regions.

The foregoing descriptions are merely embodiments of this application, but are not intended to limit this application. Any modification, equivalent replacement, or improvement made without departing from the spirit and principle of this application should fall within the protection scope of this application.

1. An audio encoding device, wherein the audio encoding device comprises:
at least one processor; and
at least one memory coupled to the at least one processor and storing programming instructions for execution by the at least one processor to perform operations comprising:
determining a current bandwidth cut-off coefficient based on a quantity of currently used bits, a quantity of channels, and a quantity of sampling points that are of an audio signal, wherein the quantity of currently used bits is a quantity of bits consumed by encoding a spectrum of a current audio frame of the audio signal before current time;
determining, based on the current bandwidth cut-off coefficient, m current to-be-encoded sub-bands from a plurality of sub-bands comprised in the spectrum, wherein m is greater than or equal to 1 and less than or equal to a total quantity of the plurality of sub-bands;
encoding target quantization scales respectively corresponding to the m sub-bands into a bitstream based on the current bandwidth cut-off coefficient, wherein a target quantization scale is a quantity of bits required for encoding frequency band information with a largest amplitude in a corresponding sub-band;
allocating quantization bits to the m sub-bands based on current remaining quantization scales respectively corresponding to the m sub-bands, wherein the current remaining quantization scale is an unallocated quantization scale remaining after a quantization bit is allocated to a corresponding sub-band last time; and
encoding frequency band information in the m sub-bands into the bitstream based on the quantization bits currently allocated to the m sub-bands.

2. The audio encoding device according to claim 1, wherein encoding the target quantization scales respectively corresponding to the m sub-bands into the bitstream based on the current bandwidth cut-off coefficient comprises:
when the current bandwidth cut-off coefficient indicates a non-full band, determining a difference between target quantization scales of every two adjacent sub-bands in the m sub-bands to obtain m-1 quantization scale differences;
determining a smallest value and a largest value in the m-1 quantization scale differences; and
encoding the target quantization scales respectively corresponding to the m sub-bands into the bitstream in a differential encoding manner if the smallest value is greater than a first threshold and the largest value is less than a second threshold.

3. The audio encoding device according to claim 2, wherein allocating the quantization bits to the m sub-bands based on the current remaining quantization scales respectively corresponding to the m sub-bands comprises:
allocating the quantization bits to the m sub-bands based on the current remaining quantization scales respectively corresponding to the m sub-bands when the current remaining quantization scales of the m sub-bands are not all 0s and are all less than a quantization step.

4. The audio encoding device according to claim 2, wherein allocating the quantization bits to the m sub-bands based on the current remaining quantization scales respectively corresponding to the m sub-bands comprises:
when a current remaining quantization scale of at least one of the m sub-bands is greater than a quantization step, performing psychoacoustic masking on the current remaining quantization scales respectively corresponding to the m sub-bands to obtain masked remaining quantization scales respectively corresponding to the m sub-bands;
scaling the masked remaining quantization scales respectively corresponding to the m sub-bands based on the quantization step to obtain scaled remaining quantization scales respectively corresponding to the m sub-bands; and
allocating the quantization bits to the m sub-bands based on the scaled remaining quantization scales respectively corresponding to the m sub-bands and the target quantization scales respectively corresponding to the m sub-bands.

5. The audio encoding device according to claim 1, wherein allocating the quantization bits to the m sub-bands based on the current remaining quantization scales respectively corresponding to the m sub-bands comprises:
allocating the quantization bits to the m sub-bands based on the current remaining quantization scales respectively corresponding to the m sub-bands when the current remaining quantization scales of the m sub-bands are not all 0s and are all less than a quantization step.

6. The audio encoding device according to claim 1, wherein allocating the quantization bits to the m sub-bands based on the current remaining quantization scales respectively corresponding to the m sub-bands comprises:
when a current remaining quantization scale of at least one of the m sub-bands is greater than a quantization step, performing psychoacoustic masking on the current remaining quantization scales respectively corresponding to the m sub-bands to obtain masked remaining quantization scales respectively corresponding to the m sub-bands;
scaling the masked remaining quantization scales respectively corresponding to the m sub-bands based on the quantization step to obtain scaled remaining quantization scales respectively corresponding to the m sub-bands; and
allocating the quantization bits to the m sub-bands based on the scaled remaining quantization scales respectively corresponding to the m sub-bands and the target quantization scales respectively corresponding to the m sub-bands.

7. The audio encoding device according to claim 1, wherein encoding the frequency band information in the m sub-bands into the bitstream based on the quantization bits currently allocated to the m sub-bands comprises:
when a current quantization layer quantity of a target sub-band is less than or equal to a maximum quantization layer quantity, and a quantization bit currently allocated to the target sub-band is 1, encoding frequency band information in the target sub-band into the bitstream in an entropy encoding manner based on the quantization bit currently allocated to the target sub-band, wherein the target sub-band is any one of the m sub-bands.

8. The audio encoding device according to claim 1, wherein encoding the frequency band information in the m sub-bands into the bitstream based on the quantization bits currently allocated to the m sub-bands comprises:
when a current quantization layer quantity of a target sub-band is less than or equal to a maximum quantization layer quantity, and a quantization bit currently allocated to the target sub-band is greater than 1, encoding frequency band information in the target sub-band into the bitstream in a binary encoding manner based on the quantization bit currently allocated to the target sub-band, wherein the target sub-band is any one of the m sub-bands.

9. The audio encoding device according to claim 1, wherein encoding the frequency band information in the m sub-bands into the bitstream based on the quantization bits currently allocated to the m sub-bands comprises:
when a current quantization layer quantity of a target sub-band is greater than a maximum quantization layer quantity, encoding frequency band information in the target sub-band into the bitstream in a binary encoding manner based on a quantization bit currently allocated to the target sub-band, wherein the target sub-band is any one of the m sub-bands.

10. The audio encoding device according to claim 1, wherein the audio signal has side information, the side information comprises an encoding flag bit, and the audio signal is an audio signal of a single channel when the encoding flag bit is a first value, or the audio signal is an audio signal of a plurality of channels when the encoding flag bit is a second value.

11. An audio decoding device, wherein the audio decoding device comprises:
at least one processor; and
at least one memory coupled to the at least one processor and storing programming instructions for execution by the at least one processor to perform operations comprising:
determining a current bandwidth cut-off coefficient based on a quantity of currently used bits, a quantity of channels, and a quantity of sampling points that are of an audio signal, wherein the quantity of currently used bits is a quantity of bits consumed by decoding a spectrum of a current audio frame of the audio signal before current time;
determining, based on the current bandwidth cut-off coefficient, m current to-be-decoded sub-bands from a plurality of sub-bands comprised in the spectrum, wherein m is greater than or equal to 1 and less than or equal to a total quantity of the plurality of sub-bands;
parsing out target quantization scales respectively corresponding to the m sub-bands from a bitstream based on the current bandwidth cut-off coefficient, wherein a target quantization scale is a quantity of bits required for encoding frequency band information with a largest amplitude in a corresponding sub-band;
allocating quantization bits to the m sub-bands based on current remaining quantization scales respectively corresponding to the m sub-bands, wherein the current remaining quantization scale is an unallocated quantization scale remaining after a quantization bit is allocated to a corresponding sub-band last time; and
parsing out frequency band information in the m sub-bands from the bitstream based on the quantization bits currently allocated to the m sub-bands.

12. The audio decoding device according to claim 11, wherein parsing out the target quantization scales respectively corresponding to the m sub-bands from the bitstream based on the current bandwidth cut-off coefficient comprises:
when the current bandwidth cut-off coefficient indicates a non-full band, parsing out the target quantization scales respectively corresponding to the m sub-bands from the bitstream.

13. The audio decoding device according to claim 12, wherein allocating the quantization bits to the m sub-bands based on the current remaining quantization scales respectively corresponding to the m sub-bands comprises:
allocating the quantization bits to the m sub-bands based on the current remaining quantization scales respectively corresponding to the m sub-bands when the current remaining quantization scales respectively corresponding to the m sub-bands are all less than a quantization step.

14. The audio decoding device according to claim 12, wherein allocating the quantization bits to the m sub-bands based on the current remaining quantization scales respectively corresponding to the m sub-bands comprises:
when a current remaining quantization scale of at least one of the m sub-bands is greater than a quantization step, performing psychoacoustic masking on the current remaining quantization scales respectively corresponding to the m sub-bands to obtain masked remaining quantization scales respectively corresponding to the m sub-bands;
scaling the masked remaining quantization scales respectively corresponding to the m sub-bands based on the quantization step to obtain scaled remaining quantization scales respectively corresponding to the m sub-bands; and
allocating the quantization bits to the m sub-bands based on the scaled remaining quantization scales respectively corresponding to the m sub-bands and the target quantization scales respectively corresponding to the m sub-bands.

15. The audio decoding device according to claim 11, wherein allocating the quantization bits to the m sub-bands based on the current remaining quantization scales respectively corresponding to the m sub-bands comprises:
allocating the quantization bits to the m sub-bands based on the current remaining quantization scales respectively corresponding to the m sub-bands when the current remaining quantization scales respectively corresponding to the m sub-bands are all less than a quantization step.

16. The audio decoding device according to claim 11, wherein allocating the quantization bits to the m sub-bands based on the current remaining quantization scales respectively corresponding to the m sub-bands comprises:
when a current remaining quantization scale of at least one of the m sub-bands is greater than a quantization step, performing psychoacoustic masking on the current remaining quantization scales respectively corresponding to the m sub-bands to obtain masked remaining quantization scales respectively corresponding to the m sub-bands;
scaling the masked remaining quantization scales respectively corresponding to the m sub-bands based on the quantization step to obtain scaled remaining quantization scales respectively corresponding to the m sub-bands; and
allocating the quantization bits to the m sub-bands based on the scaled remaining quantization scales respectively corresponding to the m sub-bands and the target quantization scales respectively corresponding to the m sub-bands.

17. The audio decoding device according to claim 11, wherein parsing out the frequency band information in the m sub-bands from the bitstream based on the quantization bits currently allocated to the m sub-bands comprises:
when a current quantization layer quantity of a target sub-band is less than or equal to a maximum quantization layer quantity, and a quantization bit currently allocated to the target sub-band is 1, parsing out frequency band information in the target sub-band from the bitstream in an entropy decoding manner based on the quantization bit currently allocated to the target sub-band, wherein the target sub-band is any one of the m sub-bands.

18. The audio decoding device according to claim 11, wherein parsing out the frequency band information in the m sub-bands from the bitstream based on the quantization bits currently allocated to the m sub-bands comprises:
when a current quantization layer quantity of a target sub-band is less than or equal to a maximum quantization layer quantity, and a quantization bit currently allocated to the target sub-band is greater than 1, parsing out frequency band information in the target sub-band from the bitstream in a binary decoding manner based on the quantization bit currently allocated to the target sub-band, wherein the target sub-band is any one of the m sub-bands.

19. The audio decoding device according to claim 11, wherein parsing out the frequency band information in the m sub-bands from the bitstream based on the quantization bits currently allocated to the m sub-bands comprises:
when a current quantization layer quantity of a target sub-band is greater than a maximum quantization layer quantity, parsing out frequency band information in the target sub-band from the bitstream in a binary decoding manner based on a quantization bit currently allocated to the target sub-band, wherein the target sub-band is any one of the m sub-bands.

20. The audio decoding device according to claim 11, wherein after parsing out the frequency band information in the m sub-bands from the bitstream based on the quantization bits currently allocated to the m sub-bands, the operations further comprise:
when parsing of a target sub-band ends, and a quantity of parsed-out bits of target frequency band information in the target sub-band is less than a target quantization scale of the target sub-band, performing low-order bit padding on the target frequency band information, wherein the target sub-band is any one of the m sub-bands, and the target frequency band information is any piece of frequency band information in the target sub-band.
